(19) United States
(12) Patent Application Publication
(10) Pub. No.: US 2025/0089016 A1
(43) Pub. Date: Mar. 13, 2025

(54) TECHNIQUES FOR DEVICE LOCALIZATION

(71) Applicant: Apple Inc., Cupertino, CA (US)

(72) Inventors: Gabrielle A. Belzberg, San Francisco, CA (US); Alexander J. Wiens, Campbell, CA (US); Halil Ibrahim Basturk, San Jose, CA (US); Benjamin A. Werner, San Jose, CA (US); Adam S. Howell, Oakland, CA (US); Hui Lin, San Jose, CA (US); Jun Kyu Lee, San Jose, CA (US); Jack D. Reilly, Sunnyvale, CA (US); Behrooz Shahsavari, Los Altos Hills, CA (US); Hojjat Seyed Mousavi, San Jose, CA (US)

(73) Assignee: Apple Inc., Cupertino, CA (US)

(21) Appl. No.: 18/806,172

(22) Filed: Aug. 15, 2024

Related U.S. Application Data
(60) Provisional application No. 63/537,761, filed on Sep. 11, 2023.
(60) Provisional application No. 63/571,724, filed on Mar. 29, 2024.

(51) Int. Cl. H04W 64/00

(52) U.S. Cl. CPC H04W 64/006

(57) ABSTRACT

In some implementations, techniques may include at a plurality of times while a user of the first portable device is moving with the first portable device: performing ranging at a respective position with a second device to determine a respective distance, thereby determining a plurality of respective distances, where the second device is stationary; obtaining raw measurements from a motion sensor of the first portable device. In addition, the device may include using the raw measurements at the plurality of times to determine relative positions at the plurality of times, the relative position from an initial position. The techniques may include estimating a second position of the second device that optimizes a loss function that includes differences of the respective distances at the relative positions and the actual distance between the relative positions and the second position.

### CROSS-REFERENCES TO OTHER APPLICATIONS

This application claims priority to U.S. Provisional Application No. 63/537,761, for “TECHNIQUES FOR DEVICE LOCALIZATION” filed on Sep. 11, 2023, and U.S. Provisional Application No. 63/571,724, for “TECHNIQUES FOR DEVICE LOCALIZATION” filed on Mar. 29, 2024, which are herein incorporated by reference in their entirety for all purposes.

### BACKGROUND

The location of a target device can be determined by exchanging with ranging measurements with a tracking mobile device. These messages, in conjunction with visual odometry techniques such as visual odometry or visual inertial odometry, can be used to triangulate the target device's position relative to the tracking mobile device. Other odometry techniques, such as inertial odometry, may not be sufficiently accurate to allow the tracking mobile device to locate the target device. Visual odometry, or visual inertial odometry, may be more accurate than inertial odometry techniques, however, capturing and processing images can be more energy and computationally demanding than inertial odometry techniques. Accordingly, improvements to triangulating a target device's location using inertial odometry are desirable.

The relative locations and orientations between a mobile device and various electronic devices can enable the mobile device to use gestures to control an electronic device. For example, a user wearing a smartwatch can turn on a television by pointing (e.g., aiming an axis perpendicular to both the smartwatch's crown and screen) at the screen and scroll through the channel list by flicking the smartwatch laterally across the screen. Implementing this functionality can necessitate continuously tracking the mobile device's position (e.g., location and orientation). Without continuous tracking, the device may not detect a user's gesture and a corresponding electronic device. However, tracking the mobile device's position in an environment can be energy intensive and traditional techniques that are sufficiently accurate to detect these gestures may not be practical for battery powered devices.

### BRIEF SUMMARY

In one general aspect, techniques may include, at a plurality of times while a user of the first portable device is moving with the first portable device: performing ranging at a respective position with a second device to determine a respective distance, thereby determining a plurality of respective distances, where the second device is stationary; obtaining raw measurements from a motion sensor of the first portable device. The techniques may also include using the raw measurements at the plurality of times to determine relative positions at the plurality of times, the relative positions determined from an initial position. The techniques may furthermore include estimating a second position of the second device that optimizes a loss function that includes differences of the respective distances at the relative positions and the actual distance between the relative positions and the second position.

Implementations may include one or more of the following features. Techniques where the raw measurements may include at least an acceleration of the first portable device. Techniques where determining relative positions may include, at each of the plurality of times: integrating the acceleration of the first portable device to calculate a velocity of the first portable device; and integrating the velocity of the first portable device to calculate a relative position of the first portable device. Techniques may include: providing the raw measurements as input to a motion model; receiving a probability that the first portable device is at the relative position as output from the motion model; and updating the relative position of the first portable device based on the probability. Techniques where determining relative positions may include, at each of the plurality of times: providing the raw measurements as input to a motion model; and receiving a probability that the first portable device is at a relative position as output from the motion model. Techniques where the motion model is a neural network. Techniques where using the raw measurements may include, at each of the plurality of times: assigning a confidence score to the raw measurements; and discarding the raw measurements if the confidence score is below a confidence threshold. Techniques where assigning the confidence score may include: providing the raw measurements as input to a motion model; and receiving the confidence score as output from the motion model. Techniques where determining the plurality of respective distances may include: detecting that movement of the first portable device is below a threshold; and prompting the user to move via an output device of the first portable device. Techniques where the output device may include a display device, a speaker, or a speaker. Techniques where determining the plurality of respective distances may include: detecting that movement of the first portable device is above a threshold; and prompting the user to continue moving via an output device of the first portable device. Techniques where the output device may include a display device, a speaker, or a speaker.

In one general aspect, techniques may include at a plurality of times while an user of the first portable device is moving with the first portable device: determining at a plurality of times relative positions at the plurality of times, the relative positions determined from an initial position. The techniques may furthermore include obtaining raw measurements from a motion sensor of the first portable device at the plurality of times. Techniques may in addition include storing the relative positions and the raw measurements as training data.

Implementations may include one or more of the following features. Techniques where determining the relative positions may include: identifying a preliminary set of positions of the first portable device through an exchange of ranging measurements with satellites of a global navigation satellite system; and identifying a subset of the set of preliminary positions with an accuracy score that exceeds an accuracy threshold as the relative positions. Techniques where the accuracy score may include a signal strength of the ranging measurements. Techniques where the relative positions are determined by visual odometry, visual inertial odometry, or simultaneous localization and mapping. Techniques where determining a relative position of the relative positions may include: capturing an image using a camera of the first portable device; providing the image as input to a combined prediction framework; receiving a position estimate as output from the combined prediction framework; and identifying the position estimate as the relative position for the first portable device. Techniques where determining a relative position of the relative positions may include: exchanging ranging measurements between the first portable device and two or more antennas; and triangulating the position of the first portable device relative to the two or more antennas. Implementations of the described techniques may include hardware, a method or process, or a computer tangible medium. Other embodiments of these techniques include corresponding methods, computer systems, apparatus, and computer programs recorded on one or more computer storage devices, each configured to perform the actions of the techniques.

A machine learning model can use inertial information to reduce the number of ranging messages that are needed to continuously track a mobile device's position relative to one or more electronic devices. Initially, a position for the device can be determined by exchanging a ranging message with one or more electronic devices. The initial position may be determined through a fusion of ranging measurements and inertial information. These ranging messages can be exchanged at a regular cadence to track the devices position, but between ranging messages, the machine learning model can use accelerometer, gyroscope, and magnetometer data (e.g., inertial information, inertial measurements, etc.) to project the mobile device's position. The ranging cadence can be lower than would be possible using other techniques because the model allows the device's position to be tracked between ranging messages. At each ranging message, the mobile device's position can be determined and used to correct for any drift in the mobile device's projected position. The mobile device's power consumption during ranging can be reduced by limiting the number of ranging messages and executing the machine learning model executing on a low power always-on-processor (e.g., auxiliary processor).

In one general aspect, techniques may include performing one or more first ranging measurements to determine a first position of the mobile device relative to an electronic device. Techniques may also include for each of N times after the one or more first ranging measurements and before a next ranging session: measuring current inertial information using an accelerometer, a gyroscope, and a magnetometer; generating a feature vector that includes the inertial information and previous inertial information obtained from one or more previous measurements; providing the feature vector to a machine learning model, where the machine learning model is trained using training feature vectors with known vector displacement to determine a current vector displacement from a previous ranging position; determining, using the model, a current vector displacement; and determining, using the first position and the current vector displacement, a current position relative to the electronic device; performing an operation on the mobile device based on an Nth position.

Implementations may include one or more of the following features. Techniques where the machine learning model executes on an auxiliary processor of the mobile device. The auxiliary processor can be separate from a central processing unit of the mobile device, and the auxiliary processor can be powered on more often than the central processing unit. Techniques where the auxiliary processor is powered on for a duration of a battery level of the mobile device being above a threshold value. Techniques where the operation may include transmitting an instruction from the mobile device to the electronic device. Techniques may include: presenting a graphical user interface on a display of the mobile device. Techniques may include: determining a difference between the Nth position and the first position of the mobile device; comparing the difference to a threshold; and responsive to the difference exceeding the threshold, performing one or more second ranging measurements to determine a second position of the mobile device relative to the electronic device. Techniques where performing the one or more first ranging measurements further may include: instructing a processor of the mobile device to enter a low power mode in response to determining the first position. Techniques where the instruction to enter the low power mode may include an instruction to reduce a clock speed of the processor. Techniques where the instruction to exit the low power mode may include an instruction to increase a clock speed of the processor. Techniques where the one or more second ranging measurements further may include: instructing the processor of the mobile device to exit the low power mode in response to determining the first position. Techniques where determining the second position further may include: measuring a second inertial information using the accelerometer, the gyroscope, and the magnetometer; and determining the second position of the mobile device relative to the electronic device using the one or more second ranging measurements and the second inertial information. Techniques may include: initiating a timer in response to determining the first position; and at a conclusion of the timer, performing one or more second ranging measurements to determine a second position of the mobile device relative to the electronic device. Techniques where determining the first position further may include: measuring a first inertial information using the accelerometer, the gyroscope, and the magnetometer; and determining the first position of the mobile device relative to the electronic device using the one or more first ranging measurements and the first inertial information. Techniques where the mobile device is a wearable electronic device. Techniques where the wearable electronic device is a head mounted display device or a smartwatch. Techniques where the mobile device is a battery powered device. Techniques where the electronic device receives alternating electric current through a wired connection to a power outlet. Techniques where each of the first position and the current position may include a location and an orientation of the mobile device in a common reference frame. Techniques where the location is a distance and a direction from the electronic device to the mobile device. Techniques where the common reference frame is a cartesian coordinate system, where an origin (0,0) of the coordinate system is a location of the electronic device. Techniques where the one or more first ranging measurements are performed in response to receiving an advertising message from the electronic device at the mobile device. Techniques where a Nth feature vector includes a (N−1)th position.

The techniques may include a computer-readable medium storing a plurality of instructions that, when executed by one or more processors of a computing device, cause the one or more processors to perform operations of any of the techniques. The techniques may include a computing device with one or more non-transitory memories and one or more processors in communication with the one or more memories and configured to execute instructions stored in the one or more memories to perform operations of any of the techniques. The techniques may include corresponding methods, systems, hardware, devices, computer program products, or non-transitory computer readable media to perform any of the techniques.

Other embodiments are directed to systems, portable consumer devices, and non-transitory computer readable media associated with techniques described herein. A better understanding of the nature and advantages of embodiments of the present disclosure may be gained with reference to the following detailed description and the accompanying drawings.

### BRIEF DESCRIPTION OF THE DRAWINGS

FIG. 1 shows a sequence diagram for performing a ranging measurement between two mobile devices according to embodiments of the present disclosure.

FIG. 2A is a simplified diagram showing the triangulation of a target device's location by a tracking mobile device that is able to accurately track the tracking device's position according to embodiments of the present disclosure.

FIG. 2B is a simplified diagram showing the triangulation of a target device's location by a tracking mobile device with uncertainty in the tracking device's position according to embodiments of the present disclosure.

FIG. 3 shows a simplified diagram of an architecture for estimating the position of a target device according to embodiments of the present disclosure.

FIG. 4 shows a simplified diagram of an orientation of the tracking mobile device with respect to a user according to at least one embodiment.

FIG. 5 shows graphs generated from the output of the range error model according to at least one embodiment.

FIG. 6 shows a simplified diagram illustrating an outliner rejection scheme according to at least one embodiment.

FIG. 7 shows a sequence diagram of a ranging operation involving a mobile device having three antenna according to embodiments of the present disclosure.

FIG. 8 is a simplified flowchart of a technique for locating a target device using a tracking mobile device according to at least one embodiment.

FIG. 9 shows a simplified diagram of an architecture for estimating the position of a mobile device according to at least one embodiment.

FIGS. 10A-10B are simplified diagrams showing the fusion of inertial and ranging data to determine movement of a mobile device relative to an electronic device according to at least one embodiment.

FIG. 11 is a simplified sequence diagram for estimating the position of a mobile device according to at least one embodiment.

FIGS. 12A-12C are simplified diagrams showing techniques to use predicted positions to control devices according to at least one embodiment.

FIG. 13 shows a technique for training a machine learning model according to at least one embodiment.

FIG. 14 shows an example machine learning model of a neural network to at least one embodiment.

FIG. 15 is a simplified flowchart of a method for estimating the position of a mobile device according to at least one embodiment.

FIG. 16 is a block diagram of components of a mobile device operable to perform ranging according to embodiments of the present disclosure.

FIG. 17 is a block diagram of an example device, which may be a mobile device according to embodiments of the present disclosure.

### DETAILED DESCRIPTION

A target's location can be determined by a tracking device through the exchange of ranging messages between the target device and an array of antennas that are each located at a different known position, e.g., telecommunications towers or navigation satellites. Traditionally, this procedure is determined through near contemporaneous exchange of messages to the antenna array which has a known configuration of locations. Such an implementation is not useful on a local scale, e.g., when one is trying to find a small device in the home. In such a situation, it is desirable for the location of a stationary target to be determined by a mobile device, which may have a single antenna, that exchanges ranging messages with the target at different positions at multiple times. The movement of the tracking mobile device can be recorded to document the relationship between the positions where each ranging message was sent. The distances between each position, and the differences between each ranging measurement, can be used to triangulate the target's location.

This triangulation technique can involve accurately tracking the movement of the tracking mobile device through odometry. Visual odometry techniques may be computationally or energy intensive, and some devices may not have the capability to perform such techniques. For example, a device may not have the capability to perform such techniques if the device lacks a camera or if the visual input is challenged in an environment (e.g., color camera in a low light environment). Instead, inertial odometry, in conjunction with a kinematics model and a human motion model, may allow for localization of the tracking mobile device that is sufficiently accurate to allow for triangulation of the target.

In some embodiments, gestures can be used for contextual control of electronic devices. A gesture can be a movement that conveys information, and, for example, a user can select a particular electronic device by pointing at the device. A user can gesture with a body part (e.g., a hand) or the user can gesture with an object such as a mobile device. Wearable mobile devices, such as a smartwatch or head mounted display device, can record a user's movements and these devices can be used to track a user's gestures.

Using a mobile device for gesture-based control of an electronic device can require tracking the mobile device's movements relative to the electronic device. The relative movements can be accurately monitored through the exchange of ranging messages between the mobile device and electronic device. However, ranging can be energy intensive and ranging based tracking of an energy constrained mobile device may not be practical over long time periods.

Alternatively, the mobile device can track movement using inertial odometry. Inertial odometry techniques involve monitoring the mobile device's sensors to detect movement. The mobile device can provide the sensor's output to a machine learning model that projects the device's displacement from a first position to a second position. However, an error in the first position can propagate to the second position and inertial odometry can become inaccurate over long time periods.

The mobile device can accurately track the device's position by combining ranging and inertial odometry. For example, the inertial odometry can be performed using the output of accelerometers, gyroscopes, and magnetometers. Ranging can be performed at regular intervals to accurately locate the mobile device. Ranging, or a combination of ranging and inertial odometry, can be used to determine an initial position for the mobile device. After this initial position is determined, the ranging cadence can be significantly reduced because, between these ranging sessions, the mobile device can use low power inertial odometry to track the device's movement. The intermittent ranging can allow the mobile device to correct for errors that have accumulated during inertial odometry, and the inertial odometry techniques can allow for accurate movement tracking with lower power consumption than would be possible with ranging alone.

### I. Ranging

In some embodiments, a mobile device can include circuitry for performing ranging measurements. Such circuitry can include one or more dedicated antennas (e.g., 3) and circuitry for processing measured signals. The ranging measurements can be performed using the time-of-flight of pulses between the two mobile devices. In some implementations, a round-trip time (RTT) is used to determine distance information, e.g., for each of the antennas. In other implementations, a single-trip time in one direction can be used. The pulses may be formed using ultra-wideband (UWB) radio technology.

### A. Sequence Diagram

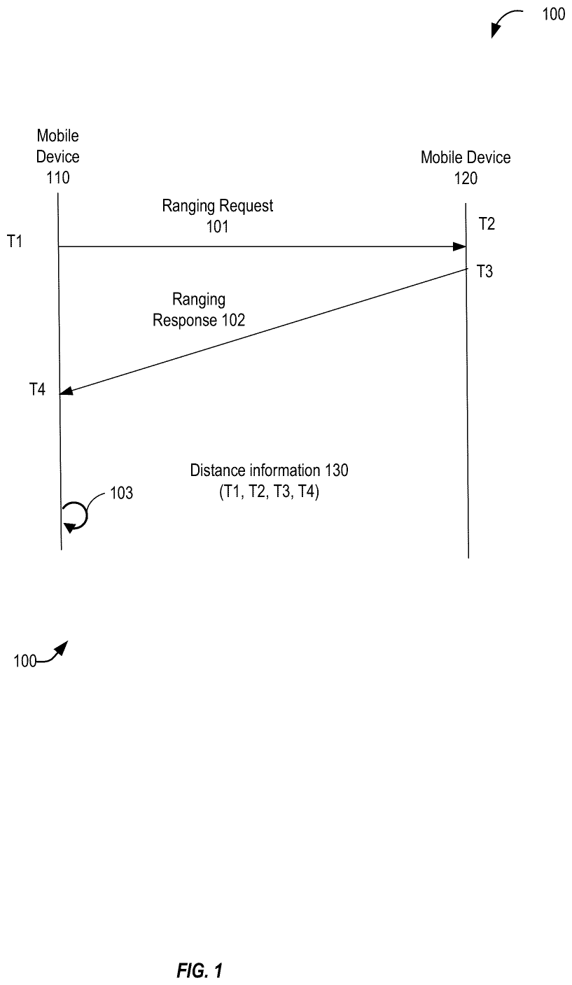

FIG. 1 shows a sequence diagram 100 for performing a ranging measurement between two mobile devices according to embodiments of the present disclosure. The two mobile devices may belong to two different users. The two users may know each other, and thus have each other's phone numbers or other identifiers. As described in more detail later, such an identifier can be used for authentication purposes, e.g., so ranging is not performed with unknown devices. Although FIG. 1 shows a single measurement, the process can be repeated to perform multiple measurements over a time interval as part of a ranging session, where such measurements can be averaged or otherwise analyzed to provide a single distance value, e.g., for each antenna.

A first mobile device 110 (e.g., a smartphone) can initiate a ranging measurement (operation) by transmitting a ranging request 101 to a second mobile device 120. Ranging request 101 can include a first set of one or more pulses. The ranging measurement can be performed using a ranging wireless protocol (e.g., UWB). The ranging measurement may be triggered in various ways, e.g., based on user input and/or authentication using another wireless protocol, e.g., Bluetooth low energy (BLE).

At T₁, the first mobile device 110 transmits ranging request 101. At T₂, the second mobile device 120 receives ranging request 101. T₂ can be an average received time when multiple pulses are in the first set. The second mobile device 120 can be expecting the ranging request 101 within a time window based on previous communications, e.g., using another wireless protocol. The ranging wireless protocol and another wireless protocol can be synchronized so that mobile device 120 can turn on the ranging antenna(s) and associated circuitry for a specified time window, as opposed to leaving them on for an entire ranging session.

In response to receiving the ranging request 101, mobile device 120 can transmit ranging response 102. As shown, ranging response 102 is transmitted at time T₃, e.g., a transmitted time of a pulse or an average transmission time for a set of pulses. T₂ and T₃ may also be a set of times for respective pulses. Ranging response 102 can include times T₂ and T₃ so that mobile device 110 can compute distance information. As an alternative, a delta between the two times (e.g., T₃−T₂) can be sent. The ranging response 102 can also include an identifier for the first mobile device 110, an identifier for the second mobile device 120, or both.

At T₄, the first mobile device 110 can receive ranging response 102. Like the other times, T₄ can be a single time value or a set of time values.

At 103, the first mobile device 110 computes distance information 130, which can have various units, such as distance units (e.g., meters) or as a time (e.g., milliseconds). Time can be equivalent to a distance with a proportionality factor corresponding to the speed of light. In some embodiments, a distance can be computed from a total round-trip time, which may equal T₂−T₁+T₄-T₃. In some embodiments, the processing time for the second mobile device 120 can also be subtracted from the total round-trip time. More complex calculations can also be used, e.g., when the times correspond to sets of times for sets of pulses and when a frequency correction is implemented.

### II. Use of Odometry to Predict Device Location

The movement of a device in physical space can be determined with odometry techniques. Odometry can refer to techniques for a device to determine its location and movement in an environment. Odometry can be performed with motion sensors (e.g., inertial measurement unit (IMU) sensors or a pedometer) and measurements from these sensors can be translated into movement within a physical environment. In addition or alternatively, odometry can be performed by comparing sequential camera frames (e.g., visual odometry).

A device using odometry techniques implemented with motion sensors (e.g., inertial odometry) can estimate the device's location and path relative to an initial position. Such techniques can be advantageous in some scenarios. Motion sensors are energy efficient, when compared to a camera, and calculating distances with a motion sensor is less computationally demanding than determining the device's position through visual odometry. For example, a rotary encoder can track a wheeled robot by counting wheel rotations, but the same robot using visual odometry would have to perform feature extraction on images for the duration of the robot's journey. In addition, a device may not have the capability to perform visual odometry. Some devices may not have cameras, and the input from a device's camera may not be sufficient to perform visual odometry in some circumstances (e.g., the ambient light is too low to capture pictures of the environment).

Visual odometry can track a device's location from the relative movement of objects as they are viewed from different perspectives (e.g., the parallax). To perform visual odometry, an initial image can be captured by a tracked device's camera, and features within this image can be identified by the tracked device's processor. The tracked device can repeatedly capture such images and extract features. The relative position of features in sequential images can be compared and used to calculate the tracked device's position.

Visual odometry techniques can be combined with inertial odometry techniques. This visual inertial odometry can compensate for some of the limitations of visual odometry and inertial odometry. Visual odometry is energy and computationally expensive, and visual odometry can be prone to errors where the device can lose track of its current position if the device is moved suddenly. This problem can be mitigated by increasing the frame rate of the camera, which reduces the distance the device's camera can move between frames. However, increasing the frame rate increases the computational and power load on the device because each image may have to be processed by the device. Inertial odometry can be good at detecting short sudden motion, but inertial sensor values are noisy, and the position determined by inertial odometry can drift over long distances. These limitations can be managed through visual inertial odometry techniques.

Visual inertial odometry can determine a device's position using both inertial and visual inputs. Visual inertial odometry techniques can be classified as loosely-coupled or tightly-coupled. In loosely-coupled visual inertial odometry, the device's position is separately estimated using visual odometry techniques and inertial odometry techniques. These results are fused to produce a final estimation for the device's position. The results can be fused using a filter such as an Unscented Kalman Filter (UKF) or an Extended Kalman Filter (EKF). In tightly-coupled visual inertial odometry techniques, the inertial measurements and the inputs from the camera are input into a combined prediction framework that outputs an estimate for the device's position. For example, the inertial measurements can be used to predict the movement of visual features between camera frames reducing the search space for the visual features. Tightly-coupled visual inertial odometry can be performed with the following formula:

$$J ( x ) = {\sum }_{i = 1}^{I} {\sum }_{k = 1}^{K} {\sum }_{j ∈ J ( i , k )} {e}_{r}^{i , j , kT} {W}_{r}^{i , j , k} {e}_{r}^{i , j , k} + {\sum }_{k = 1}^{K - 1} {e}_{s}^{k T} {W}_{s}^{k} {e}_{s}^{k}$$

J(x) is a cost function, i is the camera index (e.g., for devices with multiple cameras), k is the frame index, and j represents the landmark index. J(i,k) represents the indices of the kth frame in the i^{th} camera, eᵣ is a reprojection error term for the camera measurements, eₛ can be the temporal error term for the inertial measurements, Wₛ^{k} is the information index of the kth inertial measurement error, and Wᵣ^{i,j,k} can represent the information matrix of a respective landmark measurement. Further details of the tightly-coupled visual inertial odometry techniques can be found in: Leutenegger, Stefan et al. “Keyframe-based visual-inertial odometry using nonlinear optimization”. In: The International Journal of Robotics Research 34.3 (2015), pp. 314-334.

III. Determining Location of Target from Ranging and IMU Measurements

Ranging measurements, and the position of a tracking mobile device, can be used to triangulate the position of a target device. The tracking device's position can be used to chart a path during the search, and a sequence of ranging measurements between the two devices can be used to resolve the target device's position. The tracking mobile device's position can be determined with odometry techniques. However, the accuracy of the determined location can vary based on the accuracy of the tracking mobile device's position.

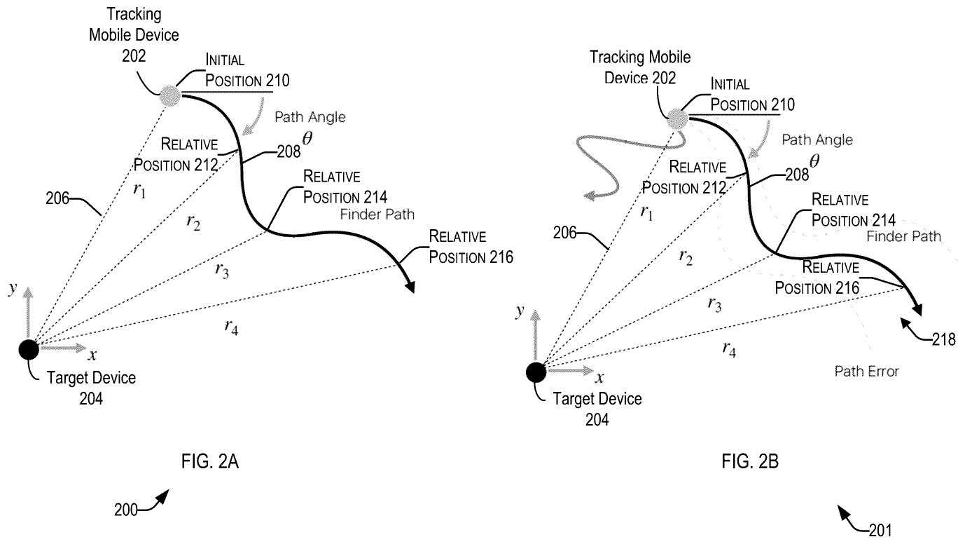

FIG. 2A is a simplified diagram 200 showing the triangulation of a target device's location by a tracking mobile device that is able to accurately track the tracking device's position according to embodiments of the present disclosure. The tracking mobile device 202 can be attempting to locate the position of target device 204. During the search, the tracking mobile device 202 can exchange a series of ranging messages 206 with the target device 204. To accurately resolve the target's location, the tracking mobile device 202 moves along a path 208 while exchanging these ranging messages 206.

This path 208 can include the positions where the tracking mobile device 202 transmitted each ranging message. For instance, ranging message r1 can be transmitted by the tracking mobile device 202 at initial position 210, ranging message r2 can be transmitted by the tracking mobile device 202 at relative position 212, ranging message r3 can be transmitted by the tracking mobile device 202 at relative position 214, and ranging message r4 can be transmitted by the tracking mobile device 202 at relative position 216.

The tracking mobile device 202 can track its position along the path 208 and, by comparing the geometry of the path 208 with the distances calculated with the ranging measurements, the location of the target device 204 can be resolved. For example, the distance calculated from each ranging measurement r1, r2, r3, and r4, can be used to create a circle, or sphere, around the point where each ranging measurement was transmitted (e.g., a circle, or sphere, with a radius equal to the distance). The location of target device 204 can be a location where the circles, or spheres, intersect. The circles or spheres can intersect if at least one point is shared by each circle or sphere.

The tracking mobile device 202 man need to move in order to locate the target device 204. The tracking mobile device 202 may use feedback to the user to induce the user to change positions. For example, a graphic on the tracking device's display may provide feedback as the device moves that induces the user to move. Alternatively, other forms of feedback can be used to induce the user to move during the search. For example, auditory or hepatic feedback may be used to induce the user to move. For example, the tracking mobile device 202 may vibrate when the user has been stationary for a threshold period of time.

FIG. 2B is a simplified diagram 201 showing the triangulation of a target device's location by a tracking mobile device with uncertainty in the tracking device's position according to embodiments of the present disclosure. During the tracking mobile device's search for the target device 204, the tracking mobile device 202 exchanges ranging messages 206 with the target device. One or both of these devices can use the ranging messages 206 to calculate ranging measurements corresponding to distances between the devices and these distances can be shared between the devices (e.g., in the payload of a subsequent ranging message 206). The tracking mobile device 202 track's its path 208 during the search and the calculated distance at points along this path can be used to determine the location of the target device 204.

This path 208 can include the positions where the tracking mobile device 202 transmitted each ranging message. For instance, ranging message r1 can be transmitted by the tracking mobile device 202 at initial position 210, ranging message r2 can be transmitted by the tracking mobile device 202 at relative position 212, ranging message r3 can be transmitted by the tracking mobile device 202 at relative position 214, and ranging message r4 can be transmitted by the tracking mobile device 202 at relative position 216.

An accurate path 208 can allow the tracking mobile device 202 to determine the location of the target device 204. With an accurate path 208, and enough calculated distances, a loss function can be minimized so that the position of the target device 204 can be located accurately. However, uncertainty in the path, as shown by the path error cone 218, can mean that there are several possible solutions to the loss function, and, for example, the target device's position may be mirrored on opposite sides of the path 208.

Inertial odometry techniques may be prone to errors that can result in inaccurate target device position calculations. However, a kinematics model, a human motion model, or the combination of a kinematics model and a human motion model can be used to minimize this error so that the tracking mobile device 202 can accurately locate the target device 204.

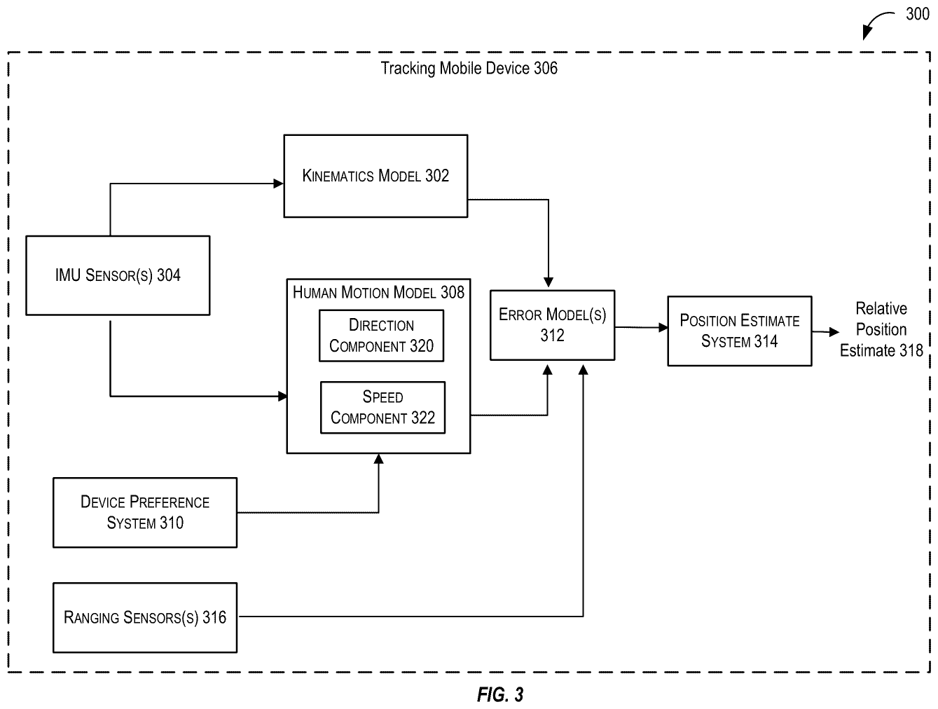

FIG. 3 shows a simplified diagram 300 of an architecture for estimating the position of a target device according to embodiments of the present disclosure. The architecture can include models that use output from various motion sensors to estimate the position of a tracking mobile device as it moves along a path. This estimated movement can be used, in conjunction with ranging measurements, to triangulate the location of a target device.

### A. Kinematics Model

The architecture can include a kinematics model 302 that can use sensor values from inertial measurement unit (IMU) sensor(s) 304 to determine the position of a tracking mobile device 306 as the device moves along a path. As examples, the sensor values output by the IMU sensor(s) 304 can be a direction of gravity relative to the tracking mobile device 306, an acceleration in a vertical plane parallel to gravity, acceleration in a horizontal plane perpendicular to gravity, a rotation of the tracking mobile device, a pitch of the tracking mobile device relative to gravity, a roll of the tracking mobile device relative to gravity, and a compass reading.

The sensor values output from the IMU sensor(s) 304 that is input to the kinematics model 302 can be the acceleration (e.g., one or more of the horizontal and vertical acceleration), and the kinematics model 302 can use this input to calculate the position of the tracking mobile device 306. For example, the kinematics model 302 may take the second integration of an acceleration measured by the IMU sensor(s) 304 to determine the position of the tracking mobile device. The first integration of the acceleration can produce velocity and the second integration of the acceleration can produce the position.

The two-dimensional speed and position of the tracking mobile device 306 can be output by the kinematics model 302 using the following equation:

$$[ \begin{matrix}{x}_{k + 1} \\ {y}_{k + 1} \\ \cdot \\ {x}_{k + 1} \\ \cdot \\ {y}_{k + 1}\end{matrix} ] = [ \begin{matrix}1 & 0 & dt & 0 \\ 0 & 1 & 0 & dt \\ 0 & 0 & 1 & 0 \\ 0 & 0 & 0 & 1\end{matrix} ] [ \begin{matrix}{x}_{k} \\ {y}_{k} \\ \cdot \\ {x}_{k} \\ \cdot \\ {y}_{k}\end{matrix} ] + [ \begin{matrix}0.5 {dt}^{2} & 0 \\ 0 & 0.5 {dt}^{2} \\ dt & 0 \\ 0 & dt\end{matrix} ] [ \begin{matrix}\cdot \cdot \\ {x}_{k} \\ \cdot \cdot \\ {y}_{k}\end{matrix} ]$$

Where dt is the time since the last state update, x, y are coordinates for the position in two dimensions, x, y are the velocity in two dimensions, x, y are the acceleration in two dimensions. The acceleration is provided as input from the gyroscope and accelerometer while the other values are calculated. The values with the subscript k represent the previously known state and the values with the subscript k+1 correspond to the updated state.

### B. Human Motion Model

Acceleration errors can accumulate over time and these errors can propagate to the position calculated by the kinematics model 302. The accuracy of the calculated position for the tracking mobile device 306 can be improved by using a human motion model 308 that calculates the device's velocity. Velocity is speed and direction, and, accordingly, the human motion model 308 can include a directional component 320 and an acceleration component.

The human motion model 308 can calculate a velocity that can be used to correct for errors in the position calculated by the kinematics model 302. The acceleration readings from the IMU sensor(s) 304 can be prone to errors. An error in a first position determined by the kinematics model 302 can be propagated to all subsequent positions. Accordingly, the position calculated by the kinematics model 302 may be unreliable in some circumstances. Sequential positions calculated by the kinematics model 302 can be compared to the velocity output from the human motion model 308. In some circumstances, the difference in positions may be inconsistent with the velocity because the tracking mobile device 306 would have to move with a different velocity to travel from a first position to a second position. In such circumstances, the second position determined by the kinematics model 302 can be rejected and substituted with a third position that is determined by moving from the first position with the velocity specified by the human motion model 308. In some embodiments, the third position can be a weighted combination of the first position and the second position. The weight for the combination can be determined by the error estimates output by the error model(s) described below. As a result, the output of the human motion model 308 can be used to correct for accumulated errors in the position determined by the kinematics model 302.

### 1. Directional Component of the Human Motion Model

The directional component 320 can use a set of rules to determine when there is a fixed relationship between the device's current orientation and the direction of the use's motion. For example, if the device is oriented with its screen perpendicular to gravity, in can be inferred that the device is being held with the screen facing directly upwards and the user is viewing the device's display to navigate to the target device. In such a configuration, a line extending from the user to the top of the device (e.g., as determined by the orientation of the text displayed on a screen of the device) is the direction of travel. The direction of travel may be a two-dimensional unit vector that is perpendicular to gravity (e.g., parallel with the floor). In some embodiments, the pitch angle and roll angle of the device may also be considered to determine whether a user is navigating with the tracking mobile device. For example, a tilt in the tracking mobile device 306 may indicate that the user has oriented the device so that the user can look at the screen during navigation.

Device preference system 310 can provide device preferences that the directional component 320 can use to infer a direction of travel for the tracking mobile device 306. The tracking mobile device 306 can be a wearable mobile device such as a smartwatch. The device preferences, such as the position on the body where the device is worn, can be provided when the device is registered with an account or with a paired device. For example, the device preferences provided by the device preference system 310 for a smartwatch can be the hand the device is worn on and the orientation of the watch crown. The device preferences can also include the user's height and stride length in some embodiments.

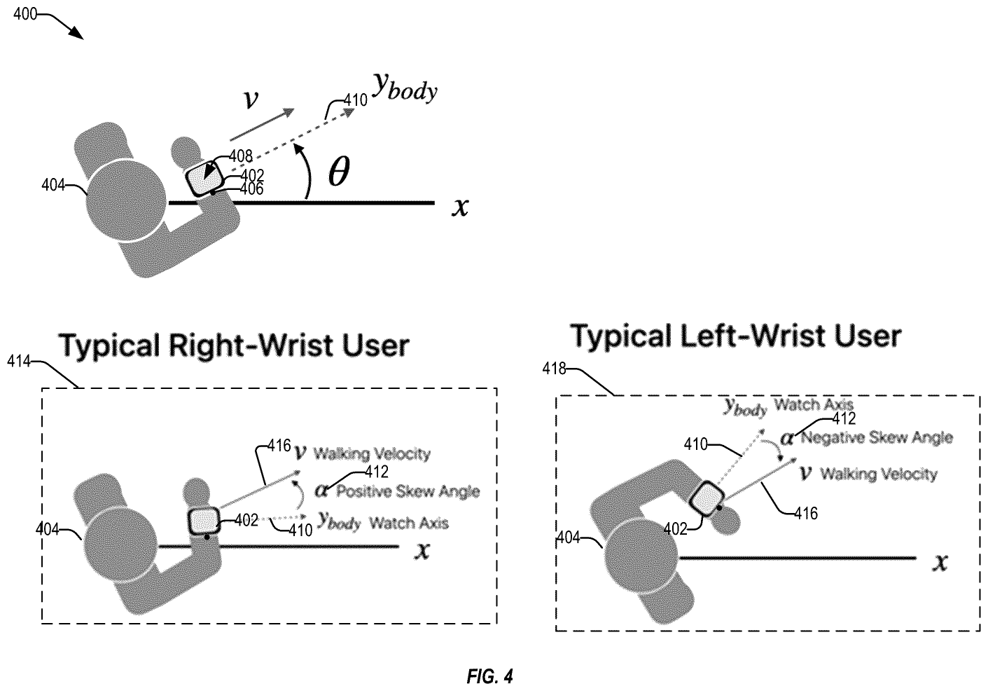

FIG. 4 shows a simplified diagram 400 of an orientation of the tracking mobile device 402 with respect to a user 404 according to at least one embodiment. The directional component 320 can run rules on the preference information and IMU sensor values to classify the orientation of the device and infer a direction of travel relative to that orientation. For example, the device preferences may indicate that the user 404 wears their device on their right arm with the crown 406 pointed up the arm. If the device screen 408 is perpendicular to the axis of gravity in this configuration (e.g., the user is holding their wrist in front of them and looking at the device screen), the direction of travel may be along an axis 410 perpendicular to the crown from the bottom of the screen to the top of the screen. In this way, the directional component 320 of the human motion model 308 can run rules on to classify the orientation of the tracking mobile device 306 and to determine a direction of travel for the device.

The preference information can be used to correct for a bias known as the skew angle 412. An offset angle for the direction, called the skew angle 412, can vary based on the device preferences that define how the tracking mobile device 402 is worn and the device's orientation relative to the user 404. The skew angle 412 can be a difference between the orientation of the tracking mobile device 402 relative to the direction of travel. In some embodiments, the magnitude of the skew angle 412 can be the same across orientations, but the sign of the skew angle can vary depending on the orientation. In some embodiments, the magnitude of the skew angle can vary depending on the device preferences and how the tracking mobile device 402 is worn.

For example, in the configuration shown in 414, the tracking mobile device 402 is worn on the right wrist. The skew angle 412 is the difference between the axis 410 and the direction of travel 416 (e.g., the direction the user is walking). The skew angle 412 in the configuration shown in 414, where the tracking mobile device 402 is worn on the right wrist, can have the same magnitude but an opposite sign (e.g., positive or negative) compared to the skew angle 412 of the configuration depicted in 418 where the tracking mobile device 402 is worn on the left wrist.

### 2. Speed Component of the Human Motion Model

Returning to FIG. 3, the human motion model 308 may include a speed component 322. This speed component 322 can comprise a machine learning model, such as a neural network, and the model can be used to estimate the speed of the tracking mobile device 306. This speed can be combined with the direction determined by the direction component 320 to determine a velocity for the tracking mobile device 306.

The human motion model 308 can be a machine learning model such as a neural network. The machine learning model can be a neural network with a set of input features (e.g., 2, 3, 4, 5, 6, 7, 8, 9, 10, 15, 20, 21, or more features) and the model can be trained with training data obtained as described below in section IV. These features can include both frequency domain and time domain features. The features can vary in significance with acceleration-based features (e.g., features related to acceleration) being the most significant. In addition, frequency domain features can hold a higher degree of significance (e.g., a higher impact on the accuracy of the model) than time domain features.

In some embodiments, the time domain features can include one or more of the following: mean of the tracking device acceleration in a horizontal plane perpendicular to gravity, the variance of the tracking device acceleration in the horizontal plane, the mean of the tracking mobile device acceleration in a vertical plane that is parallel to the direction of gravity, the variance of the tracking device acceleration in the vertical plane, the mean of rotation perpendicular to gravity, the mean of rotation around gravity, the variance of rotation perpendicular to gravity, the variance of rotation around gravity, the mean of pitch angle, mean of the roll angle, variance of the pitch angle, variance of the roll angle, and the variance of the roll angle. In some embodiments, the time domain features can include one or more of the following: the Fourier transform of the power of rotation perpendicular to gravity computed around a user's step frequency (e.g., the frequency of the users stride; between 0.5 and 3.5 Hertz), the high frequency Fourier transform power of rotation perpendicular to gravity (e.g., the high frequency is greater than 3.5 Hertz and up to 20 Hertz), the Fourier transform of the power of rotation around gravity computed around the user's step frequency, the high frequency Fourier transform of the power of rotation around gravity, the Fourier transform of the power of tracking device acceleration in the horizontal plane computed around the user's step frequency, the high frequency Fourier transform of the power of the tracking mobile device acceleration in a horizontal plane, the Fourier transform of the power of the tracking device acceleration in the vertical plane computed around the user's step frequency, and the high frequency Fourier transform of the power of the tracking mobile device acceleration in the vertical plane.

To compute the Fourier transform of the power of rotation around gravity computed around the user's step frequency, the Fourier transform amplitude of the signal is calculated. Acceleration (and rotation) signals in inertial frame can be stored in a buffer, and the Fouier transform of acceleration in three dimensions is calculated to obtain:
Ax(w),Ay(w),Az(w)
Where w is the frequency, x,y is the horizontal plane, and z is the vertical plane. The Fourier transform of power in the horizontal plane around step frequency can be calculated as:

$$HorizontalPowerAroundStep = SUM\_ \{ w in [ 0.5 Hertz 3.5 Hertz ] \} Ax ( w ) \hat{} 2 + Az ( w ) \hat{} 2$$

The Fourier transform of power in the vertical plane (or direction) around step frequency can be calculated as:

$$VerticalPowerAroundStep = SUM\_ \{ w in [ 0.5 3.5 ] \} Az ( w ) \hat{} 2$$

In some embodiments, the time domain features related to acceleration can include one or more of: the mean of the tracking device acceleration in the horizontal plane, the variance of the tracking device acceleration in the horizontal plane, the mean of the tracking mobile device acceleration in the vertical plane, and the variance of the tracking device acceleration in the vertical plane. In some embodiments, the frequency domain features related to acceleration can include one or more of: the fast Fourier transform of the power of tracking device acceleration in the horizontal plane computed around the user's step frequency, the high fast Fourier transform of the power of the tracking mobile device acceleration in the horizontal plane, the fast Fourier transform of the power of tracking device acceleration in the vertical direction computed around the user's step frequency, and the high fast Fourier transform of the power of the tracking mobile device acceleration in the vertical plane.

In some embodiments, the most significant features are: the Fourier transform of the power of the tracking device acceleration in the vertical plane computed around the user's step frequency, the Fourier transform of the power of tracking device acceleration in the horizontal plane computed around the user's step frequency, the high frequency Fourier transform of the power of the tracking mobile device acceleration in the vertical plane, and the high frequency Fourier transform of the power of the tracking mobile device acceleration in the horizontal plane

### C. Error Models and Confidence Scores for Model Outputs

Human motion can be erratic and not all of the output from the IMU sensor(s) 304 can reliably translate into an accurate position or direction of travel. This is particularly true for wearable deices that detect motion that may be unrelated to the movement in a particular direction. For example, a user wearing a watch may wave at an acquaintance or scratch their head. The IMU sensor(s) 304 may detect a large change in acceleration, however, this acceleration is not connected to positional movement of the user (e.g., movement that results in the user changing position). One or more of the kinematic model 302, the human motion model 308, or separate error model(s) 312, may assign a confidence score to readings from the IMU sensor(s) 304. In some implementations, error model(s) 312 may assign confidence scores to the output of one or more of the kinematics model 302 or the human motion model 308.

The confidence scores may be assigned by a model that is trained to distinguish between positional movement and motion that does not correspond to a change in position. The model can be trained using the training data that is obtained according to the techniques described below with respect to section IV. The training data can include the known speed or direction of a device and the sensor data corresponding to that a device moving at that speed or in that direction. The model parameters can be iteratively updated until the predicted speed or direction of movement output from the model in response to the input training data matches the known position corresponding to that input training data. In this way, patterns of input sensor data, that do not correspond to changes in the tracking mobile device's position, can be assigned a low confidence score by the model, and patterns of input sensor data that do correspond to changes in position can be assigned a high confidence score.

The error model(s) 312 may include a model that accounts for the uncertainty in the position output by kinematics model 302. Bias in the signals from the accelerometer and gyroscope in the IMU sensor(s) 304 can accumulate over time with an error in one estimated position, speed or direction output from the kinematics model 302 propagated to all subsequent estimates. Accordingly, the error model can compare the difference between sequential positions and assign a low confidence scores to a subsequent position estimate if the difference between the positions is above a threshold (e.g., the tracking mobile device may be unlikely to move 3 meters between position estimates).

The human motion model can output an estimate of the current velocity the tracking mobile device 306. The error model(s) 312 may include a model that can assign a confidence score to the velocity based on the current 3D orientation of the device relative to gravity and the stability of that orientation over time. Changes in orientation that are above a threshold may be assigned a low confidence score, and changes in orientation that are below a threshold velocity may be assigned a high confidence score.

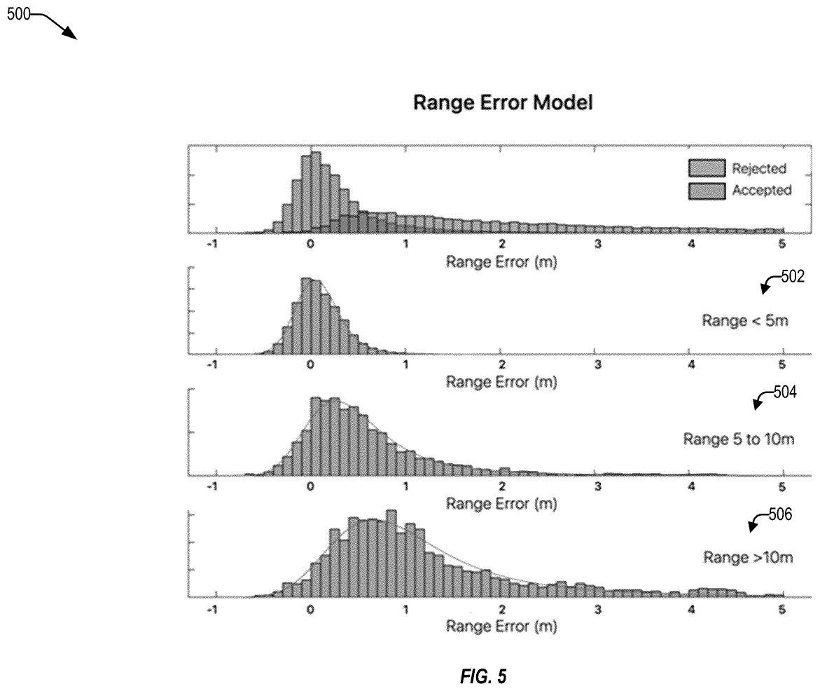

FIG. 5 shows graph 500 generated from the output of the range error model according to at least one embodiment. In some embodiments, the uncertainty of 2D velocity can be treated as a zero mean multivariate Gaussian distribution with small correlation between axes. In such embodiments, if the velocity estimate has a low confidence score due to orientation change, the covariance values can be increased leading to a wider distribution. On the other, if the velocity has a high confidence score, then the covariance value can be decreased to produce a narrow distribution. This decreased distribution increases the confidence and the velocity makes a bigger impact to our state estimation of the device.

The error model(s) 312 may include a model that assigns a confidence score to ranging measurements calculated by the ranging sensor(s) 316. This model can look at the variance of the ranging values over time. Ranging measurements calculated during time periods where the ranging measurements fluctuate may be assigned a low confidence score. Ranging measurements from time periods where the ranging measurements are stable may be assigned a high confidence score.

FIG. 5 shows graphs 500 generated from the output of the range error model according to at least one embodiment. The graph output shows how the error for ranging measurements increases as the distance between the tracking mobile device and the tracking device increases. Graph 502 corresponds to ranging measurements when the devices are within 5 meters of each other. The distribution is narrow. Graph 504 corresponds to ranging measurements that are performed when the devices are between 5 and 10 meters apart, and the distribution is wider than the distribution shown in graph 502. Graph 506 corresponds to ranging measurements that are performed when the devices are separated by greater than 10 meters. The distribution shown in graph 506 is wider than the distribution shown in either graph 502 or graph 504.

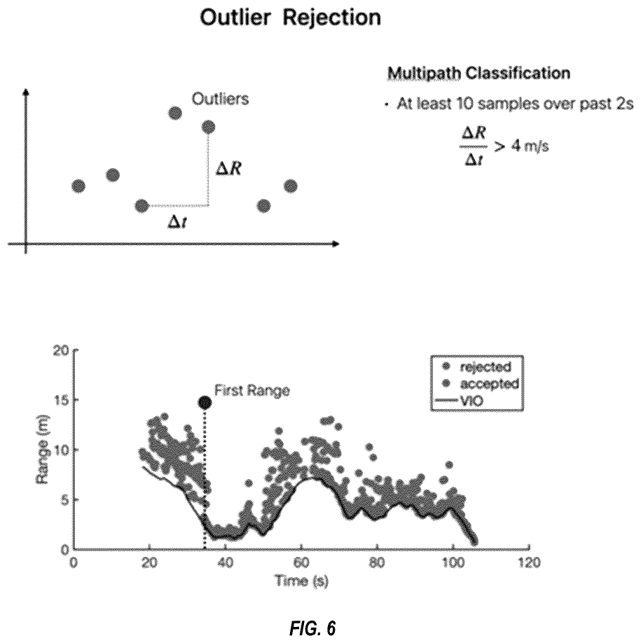

FIG. 6 shows a simplified diagram 600 illustrating an outliner rejection scheme according to at least one embodiment. The error model(s) can include an outlier rejection component to eliminate unreliable range measurements. The ranging measurements that are not rejected by the outlier rejection component can be provided to a ranging error model to assign confidence scores to the ranging measurements. Outlier rejection can include buffering range samples over a time period (e.g., 2 seconds), and error messages may only be accepted if there is a sufficient quantity of measurements in the time period (e.g., 1 sample, 2 samples, 5 samples, 10 samples, 20 samples, 50 samples, and 100 samples). The time and range shift relative to the last accepted range sample are then examined. If the time rate of change in the range is below a reasonable threshold the sample can be accepted. This process is shown in the left side of the figure at the end of the document.

To model the error for a given accepted sample, an input feature to characterize the sample. Once the feature has been defined, all the range measurements within a large pool of data collected during the design process can be combined to generate distributions of the expected error.

Diagram 600 shows distributions of expected error for ranging measurements where the ‘input feature’ is simply the range value itself. To apply this information during an actual finding session, the distributions are saved as a look-up table, then as each range measurement comes in the tracking mobile device can calculate the ‘input feature’ and then select the corresponding error distribution to characterize its quality. In some embodiments, a filter, such as a low pass filter, can be used to filter the ranging measurements.

### D. Position Estimates

Returning to FIG. 3, a position estimate system 314 can use the output of the kinematics model 302, the human motion model 308, the error model(s) 312, and the ranging sensor(s) 316 to produce a relative position estimate 318. The relative position estimate 318 can be the position of the target device relative to the tracking mobile device 306 or an initial position (e.g., the location of the tracking mobile device 306 at the beginning of the search procedure). The relative position estimate 318 can be a probability that the target device is at a two-dimensional position or a three-dimensional position in the search environment. In some embodiments, the relative position estimate 318 can be a point (e.g., an x, y, z, cartesian coordinate) or a range of coordinates identifying an area that may contain the target device.

The relative position estimate 318 can be determined by optimizing a loss function. The ranging measurements calculated from the ranging sensor(s) 316 can be taken at multiple positions as described with reference to FIG. 2A-2B. These positions can be various points along a path that can be calculated using one or more of the position speed and direction estimates output from kinematics model 302, the human motion model 308, or the error model(s) 312. The loss function can include the differences between each respective distance from the tracking mobile device 306 to the target device (e.g., as calculated by the ranging sensor(s) 316 at each position along the path), and the distance between each position on the path (e.g., as calculated by the kinematics model 302, the human motion model 308, the error model(s) 312). The position estimate system can be a particle filter in some embodiments. A detailed description of particle filters can be found in: Elfring J, Torta E, van de Molengraft R. Particle Filters: A Hands-On Tutorial. Sensors (Basel). 2021 Jan. 9; 21 (2): 438. Doi: 10.3390/s21020438. PMID: 33435468; PMCID: PMC7826670.

### IV. Generating the Speed Component of the Human Motion Model

A tracking mobile device's sensors can receive a large amount of input caused by the devices motion. However, much of this input is not related to the movement of the human holding the device. The speed component 322 of the human motion model 308 can be trained calculate the speed of the tracking mobile device that corresponds to a particular set of sensor inputs. Accordingly, the training data can includes both the sensor input and the corresponding device movement in an environment.

### A. Training Data

The training data can include output of the IMU sensor(s) 304 while the tracking mobile device 306 is moving at a known speed. In some embodiments, the training data may be limited to situations where the tracking mobile device 306 is moving in a straight line at a consistent speed. This training data for a human motion model can be obtained through visual inertial odometry or simultaneous localization and mapping. A tracking mobile device with a camera, and sufficient processing power to perform visual inertial odometry, can record the tracking mobile device's movement through an environment. This known movement can be the ground truth for the training data, and the device's speed can be calculated from the movement. While moving, the tracking mobile device can record the IMU sensor values corresponding to that that calculated speed. The model can be trained to predict the device's speed based on the input from the IMU sensors. For example, the IMU sensor values from the training data can be input to the model, and the model parameters can be tuned until the predicted motion of the device, output from the model, corresponds to the known device speed that is calculated from the training data.

Other techniques can be used to capture training data for the model. For example, positional data obtained from a global navigation satellite system can be used to capture training data. In some circumstances, the position determined by the global navigation satellite system may be sufficiently accurate to create training data. Generating this data may be opportunistic and the tracking mobile device may record segments of device movement as training data when the signal strength of the global navigation satellite system, or the accuracy of the position estimation, is above a threshold. In some circumstances, the training data obtained by the global navigation satellite system may be recorded for movement in a straight line rather than movement in multiple directions. This movement can be used to calculate the speed of the tracking mobile device, and the speed and sensor data can be correlated to generate training data.

In some embodiments, ranging messages can be used to calculate a devices' position and generate training data. Messages exchanged between multiple antennas can be used to determine the 2D or 3D motion of a device overtime. This motion data can be used to calculate the speed of the tracking mobile device, and the speed and IMU sensor data can be correlated to generate training data.

### B. Triangulation of Ranging Messages to Generate Training Data

In some embodiments, a mobile device can have multiple antennas, e.g., to perform triangulation to track a device's motion in an environment. This tracked motion can be used to calculate the tracking mobile device's speed and to generate training data for the model. The separate measurements from different antennas can be used to determine a two-dimensional (2D) position, as opposed to a single distance value that could result from anywhere on a circle/sphere around the mobile device. The two-dimensional (2D) position can be specified in various coordinates, e.g., Cartesian, or polar, where polar coordinates can comprise an angular value and a radial value. Antennas 711, 712, 713 can be arranged to have different orientations, e.g., to define a field of view for performing ranging measurements.

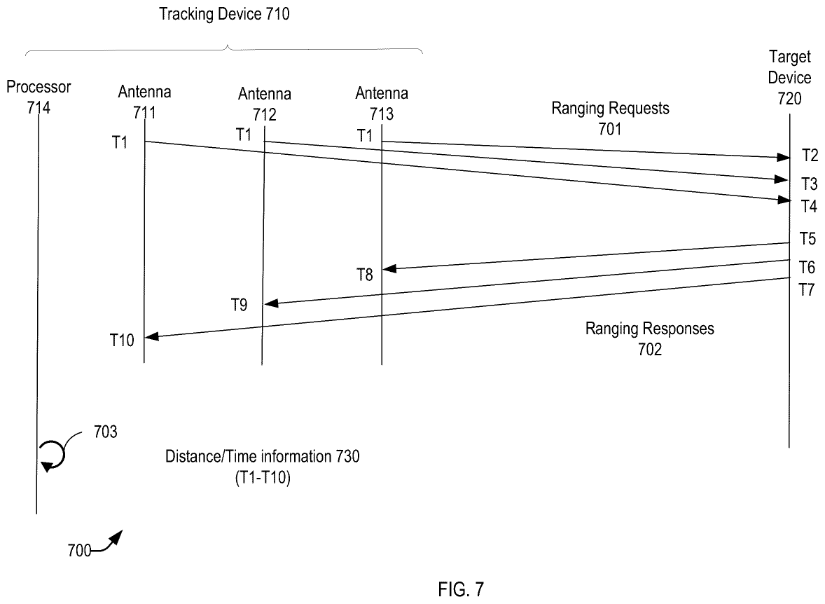

In this example of FIG. 7, each of antennas 711, 712, 713 transmits a packet (including one or more pulses) that is received by target device 720. These packets can be part of ranging requests 701. The packets can each be transmitted at time T1, although they can be transmitted at different times in other implementations.

In some embodiments, target device 720 can have multiple antennas itself. In such an implementation, an antenna of tracking device 710 can send a packet to a particular antenna (as opposed to a broadcast) of target device 720, which can respond to that particular packet. Target device 720 can listen at a specified antenna so that both devices know which antennas are involved, or a packet can indicate which antenna a message is for. For example, a first antenna can respond to a received packet; and once the response is received, another packet can be sent to a different antenna. Such an alternative procedure may take more time and power.

The three packets of ranging requests 701 are received at times T₂, T₃, and T₄, respectively. Thus, the antenna(s) (e.g., UWB antennas) of target device 720 can listen at substantially the same time and respond independently. Target device 720 provides ranging responses 702, which are sent at times T₅, T₆, and T₇, respectively. Tracking device 710 receives the ranging responses at times T₃, T₉, and T₁₀, respectively.

At 703, processor 714 of tracking device 710 computes distance information 730, e.g., as described herein. Processor 714 can receive the times from the antennas and more specifically from circuitry (e.g., UWB circuitry), that analyzes signals from antennas 711, 712, 713. As described later, processor 714 can be an always-on processor that uses less power than an application processor that can perform functionality that is more general. Distance information 730 can be used to determine a two dimensional (2D) or three dimensional (3D) position of target device 720, where such position can be used to configure a display screen of tracking device 710. For instance, the position can be used to determine where to display an icon corresponding to target device 720, e.g., which position in a list, which position in a 2D grid, or in which cluster of 1D, 2D, or 3D distance/position ranges to display the icon. The IMU sensor data corresponding to the devices movement can be stored along with a 2D or 3D position of the device as it moves through an environment. This correlated position and sensor data can be used as training data for a human motion model.

In some embodiments, to determine which ranging response is from which antenna, target device 720 can inform tracking device 710 of the order of response messages that are to be sent, e.g., during a ranging setup handshake, which may occur using another wireless protocol. In other embodiments, the ranging responses can include identifiers, which indicate which antenna sent the message. These identifiers can be negotiated in a ranging setup handshake.

Messages in ranging requests 701 and ranging responses 702 can include very little data in the payload, e.g., by including few pulses. Using few pulses can be advantageous. The environment of a mobile device (potentially in a pocket) can make measurements difficult. As another example, an antenna of one device might face a different direction than the direction from which the other device is approaching. Thus, it is desirable to use high power for each pulse, but there are government restrictions (as well as battery concerns) on how much power can be used within a specified time window (e.g., averaged over one millisecond). The packet frames in these messages can be about 150 to 30 microseconds long.

### V. Locating a Device Using the Motion Model

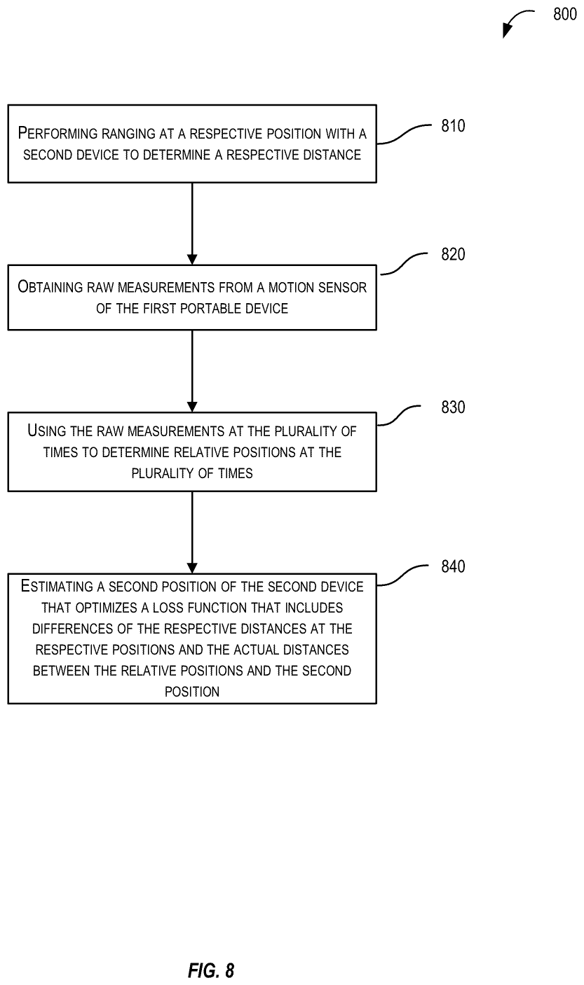

FIG. 8 is a simplified flowchart 800 of a technique for locating a target device using a tracking mobile device according to at least one embodiment. In some implementations, one or more method blocks of FIG. 8 may be performed by an electronic device (e.g., mobile device 1600, device 1700, tracking mobile device 202, or tracking mobile device 306). In some implementations, one or more method blocks of FIG. 8 may be performed by another device or a group of devices separate from or including the electronic device.

At block 810, ranging with a second device can be performed at a respective position to determine a respective distance. The ranging can include the exchange of ranging messages between the first portable device and the second device at a plurality of times. The time of flight of the ranging messages, and the signal strength of the messages, can be used to determine the respective distance between the first portable device and the second device. The ranging can be performed while a user is moving with the first portable device. The ranging can be performed by the first portable device such as the tracking mobile device 202, or the tracking mobile device 306. The second device can be a stationary device (e.g., a device that is not moving during the search or a device with movement that is below a threshold for the duration of the search so that the device is substantially at the same position).

The first portable device can exchange messages while a user is moving with the device. The first portable device may move so that the device is at different locations at each of the plurality of times. The first portable device may provide feedback to the user to induce the user to move during the search for the second device. For instance, the first portable device may detect that the movement of the first portable device is below a threshold. The movement may be measured by the IMU sensor(s) 304, and the user may be prompted to move by providing feedback from an output system in response to the movement being below a threshold. The output system can include a display system, a speaker, or a haptic system (e.g., a vibration motor). The feedback provided by the output system may be visual feedback shown on a display system of the first mobile device (e.g., a screen), the feedback may be auditory feedback provided by a speaker, or the feedback may be tactile feedback provided by a haptic system. For example, the first portable mobile device may vibrate when the movement of the first portable device is below a threshold. In some embodiments, the feedback may be provided if the user's movement is above a threshold. Such feedback can induce a moving user, who is holding the first portable device, to continue moving. For example, a display system of the first portable device my show a pattern that changes when movement is detected and this changing pattern can induce the user holding the device to continue moving.

At block 820, raw measurements can be obtained from a motion sensor of the first portable device. The motion sensor can be an accelerometer within an inertial measurement unit (IMU), and the raw measurements can correspond to the acceleration of the first portable device. The raw measurements can be the sensor values output by IMU sensors (e.g., IMU sensor(s) 304). The raw measurements can be obtained at a plurality of times while a user of the first portable device is moving along with the first portable device. In some embodiments, multiple sensors can obtain the raw measurements (e.g., two accelerometers arranged at perpendicular angles of each other).

Obtaining the raw measurements can include assigning a confidence score to the raw measurements. The raw measurements can be discarded if the confidence score is below a threshold. The confidence score may be assigned by the kinematics model 302, the human motion model 308, or error model(s) 312. In some embodiments, the confidence score can be assigned to predicted positions or velocities output by the kinematics model 302 or the human motion model 308.

At block 830, the raw measurements can be used at the plurality of times to determine relative positions of the first portable device at the plurality of times. The relative positions can locations along a path corresponding to the movement of the first portable device such as path 208. The relative positions can be determined with respect to an initial position. Some or all of the relative positions can correspond to the respective positions where ranging with the second portable device were performed.

The relative positions can be determined using the output of the kinematics model 302, the human motion model 308, and the error model(s) 312. The kinematics model 302 can calculate the relative position at a point in time by integrating the acceleration of the first portable device to calculate a velocity of the first portable device and integrating the velocity of the first portable device to calculate a relative position of the first portable device.

The relative positions can be estimated by the human motion model 308 by providing the raw measurements as input to the human motion model. The device preferences may also be provided to the human motion model 308 by the device preference system 310. The human motion model can output a probability that the first portable device is at the relative position in response to the input raw measurements and device preferences. In some embodiments, the output of the human motion model can be an estimated position or an estimated velocity. A relative position produced by the kinematics model 302 can be updated based on the estimated position, the estimated velocity, or probability that the first portable device is at the relative position. The human motion model 308 can be a machine learning model such as a neural network.

At block 840, a second position of the second device can be estimated by optimizing a loss function. The loss function can include differences of the respective distances at the respective positions and the actual distance between the relative positions and the second position. The loss function can be optimized by the position estimate system 314 to produce a relative position estimate 318.

### I. Use of Inertial and Ranging Data to Predict Positions

The movement of a device in physical space can be determined with odometry techniques. Odometry can refer to techniques for a device to determine its position and movement in an environment. The device's position can be a location and an orientation of the device. Odometry can be performed with motion sensors (e.g., inertial measurement unit (IMU) sensors or a pedometer) and measurements from these sensors can be translated into movement within a physical environment. This movement can be the movement of the device or the movement of the body of a device's user. Other sensor types may be used and, for example, output from a magnetometer can be used to determine an orientation (e.g., angle of displacement from a reference direction; degrees from North). In addition or alternatively, odometry can be performed by comparing sequential camera frames (e.g., visual odometry).

A device using odometry techniques implemented with motion sensors (e.g., inertial odometry) can estimate the device's displacement and change in orientation relative to an initial position. Such techniques can be advantageous in some scenarios. Motion sensors are energy efficient, when compared to a camera, and calculating distances with a motion sensor is less computationally demanding than determining the device's position through ranging with one or more electronic devices. For example, tracking with ranging techniques may mean that the tracked device exchanges ranging messages and calculates the device's position every 100 milliseconds.

“\*MERGEFORMAT\*MERGEFORMAT [0029] Ranging techniques can be combined with odometry techniques. This ranging-odometry fusion can compensate for some of the limitations of ranging and odometry techniques. Ranging techniques can provide accurate distance determinations over long distances and long periods of time, but these techniques can be energy intensive. In addition, ranging may require regular communication with one or more external devices in order to determine the tracked device's position. Inertial odometry can be good at detecting short sudden motion, but inertial sensor values are noisy, and the position determined by inertial odometry can drift over long distances. These limitations can be managed through ranging-odometry fusion techniques.

### A. Prediction Architecture

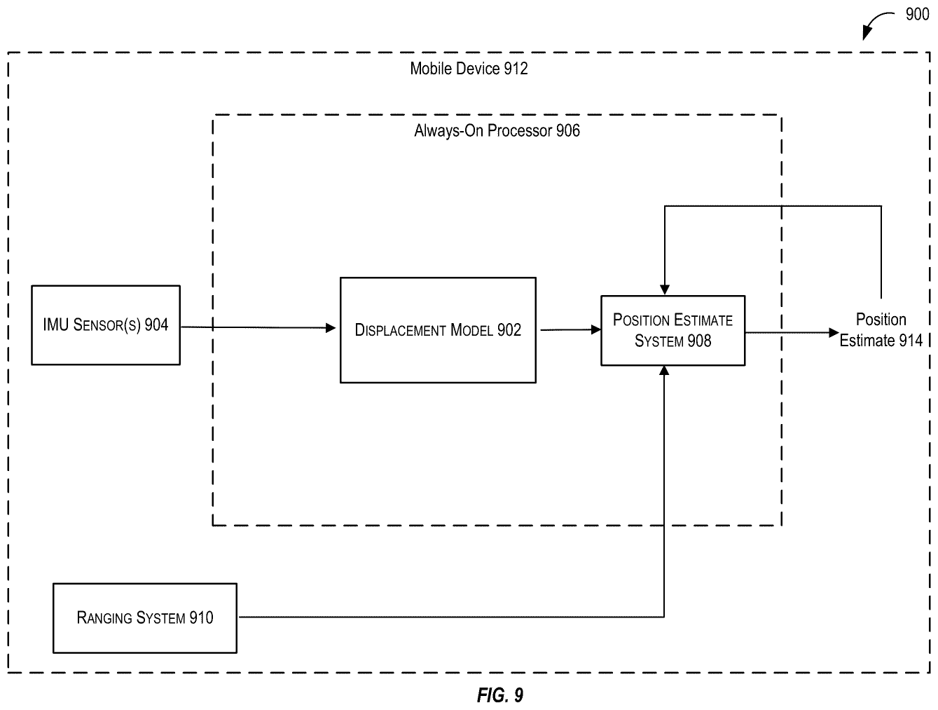

FIG. 9 shows a simplified diagram 900 of an architecture for predicting the position of a mobile device according to embodiments of the present disclosure. The architecture can include models that use output from various motion sensors, and magnetometer readings, to estimate the position of a tracking mobile device between ranging sessions. This estimated movement can be used, in conjunction with ranging measurements, to triangulate the location of a mobile device.

### 1. Displacement Model

The architecture can include a displacement model 902 that can use sensor values from inertial measurement unit (IMU) sensor(s) 904 to determine the change in position of a mobile device 912 as the device moves within a physical environment. In some embodiments, the position can be the position of the body of a user of the mobile device. As examples, the sensor values output by the IMU sensor(s) 904 can be a direction of gravity relative to the tracking mobile device 912, an acceleration in a vertical plane parallel to gravity, acceleration in a horizontal plane perpendicular to gravity, a rotation (e.g., yaw) of the tracking mobile device, a pitch of the tracking mobile device relative to gravity, a roll of the tracking mobile device relative to gravity, gyroscope readings (e.g., rotational acceleration readings), and a compass (e.g., magnetometer) reading.

The sensor values output from the IMU sensor(s) 904 that is input to the displacement model 902 can be linear acceleration (e.g., one or more of the horizontal and vertical acceleration), rotational acceleration (e.g., acceleration around one or more axes), and magnetometer readings (e.g., magnetic field measurements along one or more axes). The displacement model 902 can use this input to calculate a displacement (e.g., a net change in position over a time period) of the tracking mobile device 912. For example, the displacement model 902 may take the second integration of an acceleration measured by the IMU sensor(s) 904 to determine the displaced distance, and the rotational acceleration and magnetometer readings can be used to determine the displacement's change in orientation. The first integration of the acceleration can produce velocity and the second integration of the acceleration can produce the distance. The displacement model 902 can use a magnetometer reading to determine the orientation of the mobile device 912 at each calculated position. The model may separately determine location and orientation, and, in some embodiments, the displacement model 902 may include a model for determining location and a model for determining orientation. The displacement can be a net change of two-dimensional or three-dimensional coordinates in any coordinate system (e.g., cartesian coordinates). In some embodiments, the displacement can include coordinates and an orientation relative to a reference direction (e.g., relative to magnetic north).

The input to the displacement model 902 can be an ordered list of numeric properties corresponding to the current location of mobile device 912 (e.g., position estimate 914). This ordered list can be a feature vector, and the feature vector can include the output of IMU sensor(s) 904. For example, the feature vector can include linear acceleration along three perpendicular axes, an angular acceleration around the three axes, and a magnetic field in the three axes. The linear accelerations can be output by one or more accelerometer(s) of the IMU sensor(s) 904, the angular acceleration can be output by one or more gyroscope(s) of the IMU sensor(s) 904, and the magnetic fields can be output by one or more magnetometer(s) of the IMU sensor(s) 904. In some implementations, the feature vector can include transformations of the output of the IMU sensor(s) 904. For example, the feature vector can include higher order derivatives calculated from the output of the IMU sensor(s) 904 (e.g., position calculated from acceleration). The transformations can include statistical operations such as excluding outlier measurements or calculating aggregated statistics for the output of the IMU sensor(s) 904 (e.g., mean, median, mode, standard deviation, etc.). The output of the IMU sensor(s) 904 may be the output of the IMU sensor(s) over a period of time and a feature vector may be generated for each period of time. The feature vector for a current time period may include information for one or more preceding time periods. For example, the feature vector may include a position estimate 914 for one or more preceding time periods or the output of IMU sensor(s) 904 over different time periods. The output of the IMU sensor(s) may be processed before the output is included in a feature vector. For example, the output of the IMU sensor(s) 904 may be rotated from a first frame of reference to a second frame of reference (e.g., so that the data represented in the feature vector is in a single reference frame).

### 2. Position Estimate System

The change in position calculated by the displacement model 902 may be a displacement of the mobile device, or the mobile device's user, relative to a previous position. Because the displacement model's position estimate is based on a previous position (e.g., position estimate 914 for a preceding time period), errors in the output of the displacement model 902 can accumulate over time. The accuracy of the calculated position for the tracking mobile device 912 can be improved by using a position estimate system 908 that uses output of ranging system 910 to mitigate the displacement model's errors.

The position estimate system 908 can filter the output of the displacement model 902 and the ranging system 910 to generate a position estimate 914 for mobile device 912. However, the readings from the IMU sensor(s) 904 can be prone to errors. An error in a first displacement determined by the displacement model 902 can be propagated to all subsequent displacements. Accordingly, the change in position calculated by the displacement model 902 may be unreliable in some circumstances.

The output of the position estimate system can be a displacement of a mobile device or a mobile device's user. For example, a wearable mobile device, such as a smartwatch head mounted display, may have a known fixed relationship to the user's body. The position estimate system 908, or the displacement model 902, can use this relationship to use the device's movement to estimate a corresponding movement of the user's body. The movement of the user's body may be determined using any combination of the displacement model 902, one or more additional machine learning models, or one or more rules. The input vector for the displacement model 902, or any other model, may include the user's preferences for the wearable device (e.g., watch hand, watch crown orientation, etc.).

In addition, mobile devices that are not worn, such as smartphones, may be used in predictable ways that have a known relationship to the user's body even if the device is not worn by the user. For example, such mobile devices may be carried in either hand, placed in a pocket or placed in a bag. There may be a particular IMU sensor profile for each device location, and the displacement model, one or more additional models, or one or more rules, can be used to classify the device's relationship to the user's body and predict the user's motion.

The position estimate system 908 may separately estimate the displacement and the orientation. For example, the displacement may be determined using the output of the displacement model 902, and the position estimate system 908 may use a magnetometer reading from the IMU sensor(s) 904 to determine orientation. In some embodiments, the output of the IMU sensor(s) 904 may be provided directly to the position estimate system 908.

### 3. Ranging System

The ranging system 910 can include one or more processor(s) and one or more radio frequency antennas, and the ranging system 910 can project distance relative to the antennas of one or more electronic devices. Each distance can be calculated by measuring characteristics of messages sent between an antenna of the mobile device 912 and an antenna of an electronic device. For example, the characteristics can include the time of flight and received signal strength indicator for a message. The characteristics have a known relationship with distance and the characteristics can be used to calculate a distance between the transmitting and receiving antenna as described above in section I.

A distance can be calculated for each unique pair of transmitting and receiving antennas. Accordingly, the uncertainty of the position calculated by the position estimate system 908 using the output of the ranging system 910 decreases with the number of available antennas. For example, the output of the ranging system 910 can be used to calculate a linear distance between the mobile device and an electronic device, with a known position, if there is one antenna on each device. In such circumstances, the calculated position may be sufficiently uncertain that the mobile device may be located anywhere on a circle surrounding the electronic device (e.g., a circle with a radius equal to the calculated distance). A calculated position can be uncertain if there are more than a threshold number of possible positions. However, a two-dimensional position or three-dimensional position of mobile device 912 can be calculated if two or three distances to electronic devices with known locations are available. In some embodiments, the ranging system can use the characteristics of ranging messages to calculate an orientation for the mobile device (e.g., through phase difference of arrival).

In some embodiments, the position estimate system 908 may designate the output of the ranging system 910 as the location and orientation (e.g., position) of mobile device 912 if the output is sufficiently accurate (e.g., the output is a three-dimensional position with orientation). In such embodiments, the output of the displacement model 902 is used to save power by enabling low power position projections between ranging sessions, but the position estimate system 908 may not use the displacement model results when current ranging system outputs are available.

### 4. Fusion of Inertial and Ranging Data

The position estimate system 908 may reduce the uncertainty of position estimate 914 by fusing the output of displacement model 902 and ranging system 910. In some circumstances, the position estimate system 908 can calculate multiple position estimates 914 that are consistent with both outputs. The position estimates 914 can be saved, and, at each subsequent ranging session, the output of the displacement model 902 and the ranging system 910 can be compared to the current and saved position estimates. The position estimates that are inconsistent with both output can be removed from the current and saved position estimates (e.g., by a particle filter). This process can iteratively occur for subsequent ranging sessions until the uncertainty of the position estimates is minimized (e.g., the number of position estimates at each ranging session is below a threshold). This fusion can be used to determine the initial position of a mobile device and to track a device's movement. In addition, the uncertainty can be a probability that an estimated position corresponds to a device's actual position (e.g., the device's position in a physical environment). The uncertainty can be used to trigger ranging sessions in some embodiments. For example, a mobile device may trigger a ranging session, or increase the cadence of ranging measurements, if the uncertainty exceeds a threshold.

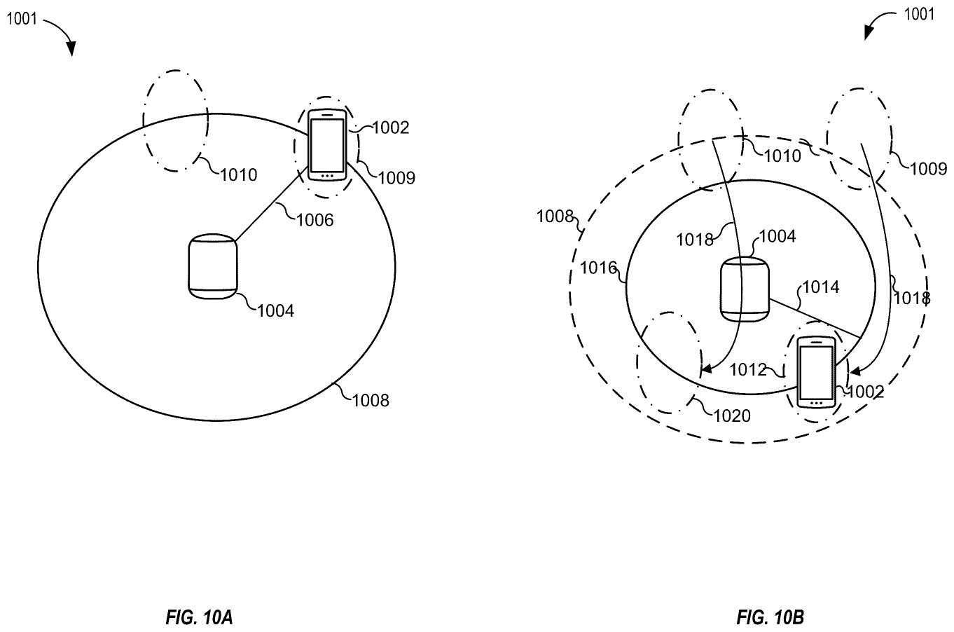

Turning now to FIGS. 10A-10B, FIGS. 10A-10B are simplified diagrams 1000-1001 showing the fusion of inertial and ranging data to determine the movement of a mobile device relative to an electronic device. Diagram 1000 shows a first time period and diagram 1001 shows a second time period. In diagram 1000, a mobile device 1002 can exchange ranging messages with an mobile device 1004 at the first time period. The mobile device 1004 can have a known location, and either the electronic device or the mobile device 1002 can use characteristics of the ranging messages to calculate a first distance 1006 between the two devices. The distance indicates that the mobile device 1002 can be anywhere on a first circle 1008 with a radius equal to first distance 1006. The position estimate can include a location and an orientation. The orientation can be an orientation relative to magnetic north as determined by a magnetometer of the mobile device 1002. The location component of the position estimate for the time period shown in diagram 1000 can include any number of locations on the first circle 1008, but, in this simplified example, the potential locations can be a first potential location 1009 corresponding to the location of mobile device 1002, as shown in diagram 1000, and a second potential device location 1010. While a device is shown at each position, the position estimate can be an estimate of the location of the device's user.

Turning now to FIG. 10B, in diagram 1001, the mobile device 1002 moved from the first potential location 1009 to a third potential location 1012 corresponding to the location of mobile device 1002 as shown in diagram 1001. At this new location, the mobile device 1002 and the mobile device 1004 can exchange ranging messages, and the ranging system for either device can use properties of the exchanged messages to calculate a second distance 1014 between the devices. The second distance 1014 can be used to calculate a second circle 1016 that the ranging message suggest contains the electronic device's current location. In addition, a displacement model executing on either device can use the sensor values for mobile device 1002 to project the device's displacement 1018 over the time period between diagrams 1000-1001. The displacement 1018 can include a distance and orientation that was traveled between diagrams.

The displacement 1018 and the two distances 1006, 1014 can be cross referenced to determine whether to exclude any of the potential locations. Valid locations would be consistent with the mobile device 1002 starting on the first circle 1008, traveling along a valid path by displacement 1018, and ending on second circle 1016. First potential location 1009 is valid because mobile device 1002 can move by displacement 1018 from the first potential location 1009 to the location of mobile device 1002 as shown in 1001 (e.g., the third potential location 1012). The second potential location 1010 is not valid because a device moving from the second potential location 1010 along displacement 1018 would have to travel through a known obstacle, device 1004, to arrive at a fourth potential location 1020. The net displacement can be used to exclude potential locations if movement along the displacement would not end on the most recent circle that was determined by ranging measurements. A particle filter can be used to compare the ranging distances and displacements and to exclude inconsistent potential locations.

### B. Sequence Diagram for Predicting Positions

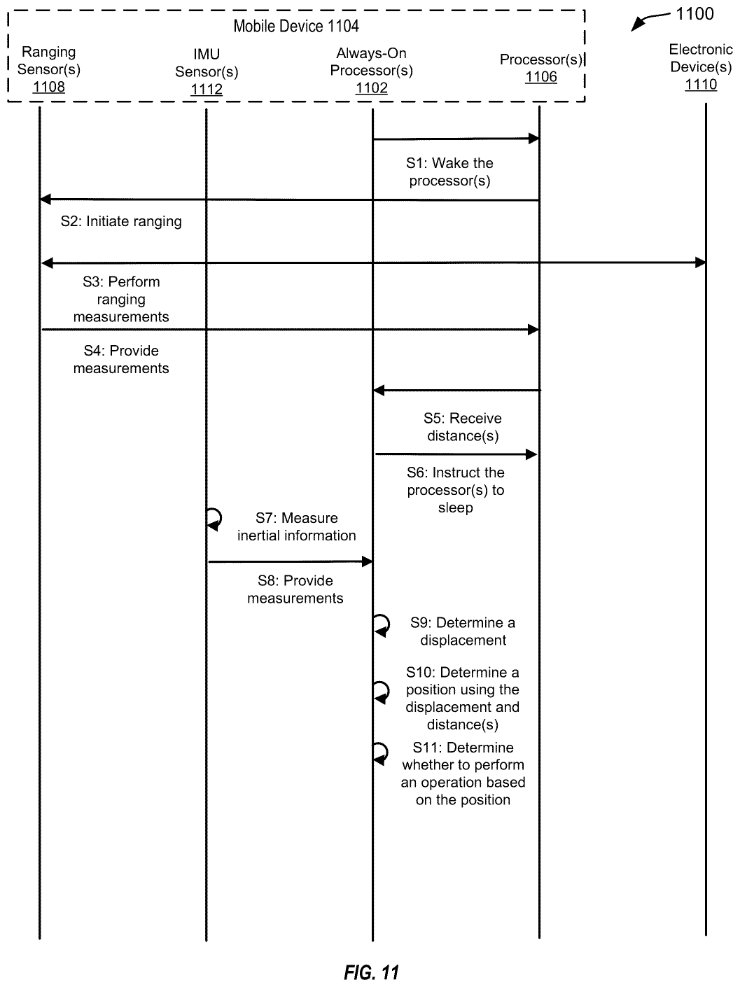

FIG. 11 is a simplified sequence diagram for estimating the position of a mobile device according to at least one embodiment. At S1, always-on processor(s) 1102 of a mobile device 1104 can wake processor(s) 1106 (e.g., cause the processor(s) 1106 to leave a low power mode). An always-on processor can be an auxiliary processor. This auxiliary processor (e.g., always-on processor(s) 1102) can be separate from a central processing unit (e.g., processor(s) 1106), and the auxiliary processor can be powered on more often than the central processing unit. For example, the always-on processor(s) 1102 can be powered on for a duration of a battery level of the mobile device being above a threshold value. In some embodiments, output of the ranging sensor(s) 1108 can wake the processor(s) 1106 from a low power mode (e.g., by instructing the processor to increase a clock speed). The processor(s) 1106 may be woken at regular intervals (e.g., after a set period of time) in some embodiments. In some embodiments, the processor(s) 1106 may be woken in response to an event (e.g., input to the mobile device 1104).

At S2, the processor(s) 1106 can instruct the ranging sensor(s) 1108 to initiate ranging. In some embodiments, the instruction to initiate ranging can be provided to the ranging sensor(s) 1108 to the always-on processor(s) 1102. In some embodiments, the processor(s) 1106 and the ranging sensor(s) 1108 can form part of the ranging system 210 described above with reference to diagram 200. In some embodiments, the processor(s) 1106 may begin ranging in response to a message received at the ranging sensor(s) 1108 from the electronic device 1110.

At S3, ranging measurements can be performed between the ranging sensor(s) 1108 and one or more electronic device(s) 1110. The ranging sensor(s) 1108 can include one or more radiofrequency antennas and each of the electronic device(s) 1110 can include one or more radiofrequency antennas. The ranging sensor(s) 1108 can include additional hardware such as tuning banks that can be used to tune the radiofrequency antennas. The ranging sensor(s) 1108 can include radiofrequency antennas that are configured to send and receive messages using one or more protocols. For example, the protocols can include ultrawideband (UWB) protocols or Bluetooth protocols (e.g., Bluetooth Low Energy (BLE)). The one or more electronic device(s) 1110 may provide their location(s) in a common coordinate system in some embodiments (e.g., the relative locations of the electronic devices).

At S4, the ranging sensor(s) 1108 can provide the measurements to the processor(s) 1106. The measurements can be provided as raw measurement data or the measurements may be transformed before they are provided to the processor(s) 1106. The ranging measurements can be one or more properties of radiofrequency signals received at the ranging sensor(s) 1108. For example, the ranging measurements can be time of flight measurements, received signal strength indicators, phase difference of arrival measurements, etc.

At S5, the always-on processor(s) 1102 may receive distance(s) from the processor(s) 1106. The distances may be calculated by the processor(s) 1106 using one or more of the measurements provided at S4. In some embodiments, the always-on processor 1102 may calculate the distances. In some embodiments, the electronic device 1110 may use ranging measurements to determine the distance(s). In such circumstances, the electronic device 1110 can provide the distance(s) to the mobile device 1104.

At S6, the always-on processor 1102 may instruct the processor(s) to sleep. In some embodiments, the processor(s) 1106 may enter a sleep mode (e.g., a low power mode) in response to providing the distances at S5 without any input from the always-on processor(s) 1102. The processor(s) 1106 may enter a sleep mode after a set period of time, or after a set period of time without receiving an input (e.g., without receiving measurements).

At S7, the inertial measurement unit (IMU) sensor(s) 1112 may measure inertial information. The IMU sensor(s) 1112 can include one or more of each of the following sensor types: an accelerometer, a gyroscope, and a magnetometer. Inertial information can be measured continuously or periodically (e.g., for fixed time periods spaced at regular intervals). The inertial information can be measured concurrently with any of S1-S11.

At S8, the inertial measurements can be provided from the IMU sensor(s) 1112 to the always-on processor 1102. The inertial measurements may be provided as the raw output of the IMU sensor(s) 1112. In some embodiments, one or more of the inertial measurements may be transformed from a first format to a second format. The inertial measurements can include linear acceleration measurements, rotational acceleration measurements, magnetic field measurements, etc.

At S9, a displacement (e.g., a vector displacement) can be determined by the always-on processor(s) 1102 using the inertial measurements at S8. The always-on processor(s) 1102 can use the inertial measurements to prepare one or more input vectors (e.g., feature vectors). An input vector may be prepared for each time period (e.g., using inertial measurements for a time period between contiguous ranging sessions). An input vector can include information from preceding input vectors in some embodiments. These vectors can be input to a displacement model executing on the always-on processor(s) 1102. The displacement model may execute on the processor(s) 1106 in some embodiments. The displacement model may output a displacement in response to the input feature vector. The displacement can be a displacement vector with a distance and direction corresponding to the input vector. The direction can be an orientation within a fixed reference frame, and this reference frame can be common to each output displacement vector.

At S10, the always-on processor(s) 1102 can determine a position using the displacement from S9 and the distance(s) from S5. The always-on processor 1102 may use preceding positions (e.g., locations corresponding to preceding time periods) to determine the position. The position can be multiple possible positions in some embodiments. In such embodiments, the always-on processor(s) 1102 may use a filter (e.g., a particle filter) to compare the displacement, distance(s), and previous positions to exclude one or more of the possible positions.

At S11, whether to perform an operation based on the position can be determined by the always-on processor 1102. In some embodiments, whether to perform an operation can be determined by the processor(s) 1106. The position can include a distance and direction relative to one or more of the electronic device(s) 1110. In some embodiments, the position can include an orientation of the mobile device 1104. The always-on processor(s) 1102 can use the distance, direction, and orientation to project a vector extending from the mobile device 1104 along the device's orientation. The projected vector may have a fixed relationship to the device's orientation rather than extending along the orientation in some embodiments. For example, the projected vector for a smartphone can be a ray extending from the top of the smartphone along the phone's long axis.

The always-on processor(s) 1102 may determine to perform an operation if the projected vector intersects (e.g., is within a threshold angle of intersecting) one or more of the electronic device(s) 1110. The always-on processor(s) 1102 may determine to not perform an operation if the distance between the mobile device 1104 and the intersected electronic device is above a threshold. The threshold angle or distance may change based on the type of electronic device. The operations can include changing the graphical user interface of the mobile device or causing one or more parameters of the electronic device to change (e.g., turn on the display of the electronic device).

### II. Use of Predicted Positions to Control Devices

The relative positions of a mobile device and electronic devices can be used to trigger operations on the devices. As an example, a user may attempt to use a mobile device to play an audio file on a smart television. However, there are multiple eligible electronic devices in the mobile device's current environment, and selecting the appropriate electronic device through the mobile device's graphical user interface can be challenging. Instead, the user can point the mobile device at the television and the mobile device's location and orientation relative to the television can indicate the user's selection.

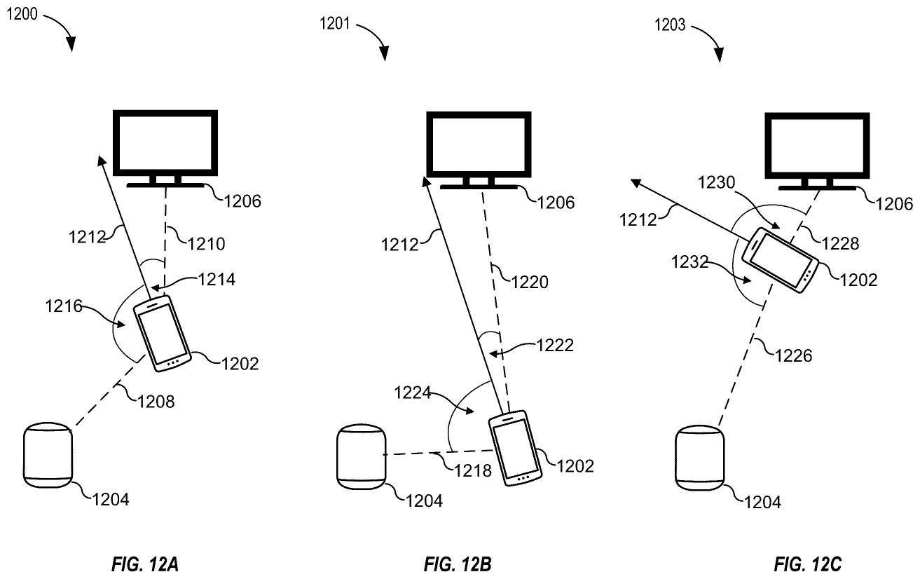

FIGS. 12A-12C are simplified diagrams 1200, 1201, and 1203 showing techniques to use predicted positions to control devices according to at least one embodiment. Turning now to FIG. 12A, a mobile device 1202 can perform ranging with electronic devices 1204-1206 to determine distances 1208-1210, and these distances can be used to triangulate the position of mobile device 1202 relative to the electronic devices 1204-1206. While only two electronic devices are shown in FIGS. 12A-12C, the mobile device 1202 may range with three or more electronic devices to perform triangulation. In some circumstances, the mobile device 1202 may combine ranging and inertial measurements to perform triangulation with fewer than three electronic devices (e.g., triangulation-over-time). In addition, the electronic devices 1204-1206 can exchange ranging measurements to determine the relative positions of each device. The position of mobile device 1202 and electronic devices 1204-1206 can be determined in a common reference frame, and the positions of the mobile device 1202, or either of the electronic devices 1204-1206, can be set as the origin of the coordinate system. In some embodiments, the origin of the coordinate system may not be a position corresponding to a device.

Mobile device 1202 can use inertial information to predict the mobile device's displacement between ranging sessions. The displacement can be the movement relative to the last ranging determined position for the mobile device 1202. In addition, the inertial information can be used to determine the orientation of mobile device 1202, and inertial information can be used to determine the orientation during a ranging session. In some embodiments, measurements calculated from ranging measurements can be used to determine the orientation of mobile device 1202.

The mobile device's orientation can be used to determine a ray 1212 extending from mobile device 1202. This ray 1212 can have a fixed relationship to mobile device 1202 and, for example, the ray can a line that extends from the center of a top surface of the mobile device along a path that is parallel to the device's screen and perpendicular to the device's top surface. The orientation of the mobile device 1202, and the positions of devices 1204-1206, can be used to determine if the mobile device is pointing at a particular device. For example, an angle 1214 can be calculated relative to a line extending from a centroid of the mobile device 1202 and electronic device 1206. In some embodiments, the line used to calculate the angle 1214 can extend between one or more ranging antennas of the mobile device 1202 and one or more ranging antennas of an electronic device. The mobile device can be determined to be pointing at an electronic device if angles 1214-1216 (e.g., the offset angles) are below a threshold offset angle for a threshold amount of time. An angle, such as angles 1214-1216, can be determined for each electronic device within a threshold range of the mobile device 1202 (e.g., each device that is able to exchange ranging messages with the mobile device 1202). Each of angles 1214-1216 can be either two-dimensional or three-dimensional angles in any coordinate system and in any units (e.g., degrees, radians, etc.)

Angles 1214-1216 can be used to determine whether to trigger operations on mobile device 1202 and electronic devices 1204-1206. For example, a user may provide input instructing mobile device 1202 to cause an electronic device to play an audio file. The input may be a selection on a graphical user interface (e.g., pressing a graphical element labeled “remote play”) or any other appropriate input (e.g., gesturing with the device). The input may initiate a technique for selecting an electronic device to play the audio file. For example, the techniques may cause mobile device 1202 to select an electronic device that is within a first threshold distance and a threshold offset angle of the mobile device. Both distance 1208 and distance 1210 can be within the first threshold distance, however, only the angle relative to electronic device 1206 (e.g., angle 1214) is within the threshold offset angle. The angle relative to electronic device 1204 (e.g., angle 1216) is not within the threshold offset angle, and, therefore, the mobile device 1202 can instruct electronic device 1206 to play the audio file.

Turning now to FIG. 12B, mobile device 1202 is separated from electronic devices 1204-1206 by distances 1218-1220. As discussed above, the mobile device 1202 may be performing a technique to select an electronic device that will be instructed to play an audio file. Electronic device 1204 is within the first threshold distance of mobile device 1202, but the offset angle between the two devices (e.g., angle 1224) is above a threshold. In some implementations, mobile device 1202 may select electronic device 1204, regardless of the offset angle relative to electronic device 1204, if distance 1218 is within a second threshold distance (e.g., mobile device 1202 is sufficiently close to electronic device 1204 to indicate a selection). However, in some embodiments, mobile device 1202 may not select electronic device 1204 even if the distance 1218 is within the second distance threshold. In such embodiments, the mobile device 1202 may not select electronic device 1204, even though distance 1218 is within the second distance threshold, because the offset angle relative to electronic device 1206 (e.g., angle 1222) is within the angle threshold (e.g., mobile device 1202 is pointing at electronic device 1206). For example, a user who is pointing their mobile device at a television while sitting near a speaker likely intends to control the television.

Turning now to FIG. 12C, mobile device 1202 is separated from electronic devices 1204-1206 by distances 1226-1228. As discussed above, the mobile device 1202 may be performing a technique to select an electronic device that will be instructed to play an audio file. Mobile device 1202 is within the first threshold distance of electronic device 1206, but the offset angle between the two devices (e.g., angle 1230) is above a threshold. In some implementations, mobile device 1202 may select electronic device 1206, regardless of the offset angle relative to electronic device 1206, if distance 1228 is within a second threshold distance (e.g., mobile device 1202 is sufficiently close to electronic device 1206 to indicate a selection). As shown in FIG. 12C, the offset angle relative to electronic device 1206 is above the offset angle threshold, and the angle relative to electronic device 1204 is also above the offset angle threshold. In such circumstances, where no offset angle is below the offset angle threshold, mobile device 1202 may select electronic device 1206 because distance 1228 is below the second distance threshold and the mobile device 1202 is not pointing at a particular electronic device (e.g., as determined by offset angles).

The orientation of ray 1212 can be configurable in some embodiments. The mobile device 1202 may allow a user to configure the surface through which the ray extends from the mobile device. For example, ray 1212 may extend from the top of the mobile device, the bottom of the mobile device, the screen of the mobile device, the back side of the mobile device (e.g., the surface opposite to the screen), or either of the sides of the mobile device. In some embodiments, the ray extending from the mobile device 1202 may change based on the orientation of the mobile device relative to gravity. For example, a mobile device that is held with the screen facing up or down (e.g., the screen is perpendicular to gravity) may have a ray that extends from the top of the mobile device (e.g., ray 1212). However, if the mobile device is held so that the screen is facing the user (e.g., the screen is parallel to gravity), the ray may extend from a surface of the mobile device that is opposite to the screen.

Gestures can be used to trigger operations on the mobile device or the electronic devices. These gestures can be detected by monitoring the offset angle over time. For example, the user can flick mobile device 1202 from left to right to skip to the next song in a playlist while a right to left motion would return to a preceding song in the playlist. Each flick could be determined by detecting that the offset angle has crossed zero (e.g., the ray has passed over the centroid of a mobile device) and the change in the offset angle over time can be used to determine a direction for the movement (e.g., left to right or right to left). The relative positions of mobile device 1202 and electronic devices 1204-1206 can be used to trigger actions on any of the devices. For example, mobile device 1202 may be show a graphical user interface for electronic device 1206 if the mobile device is pointing at the electronic device.

### III. Model Training

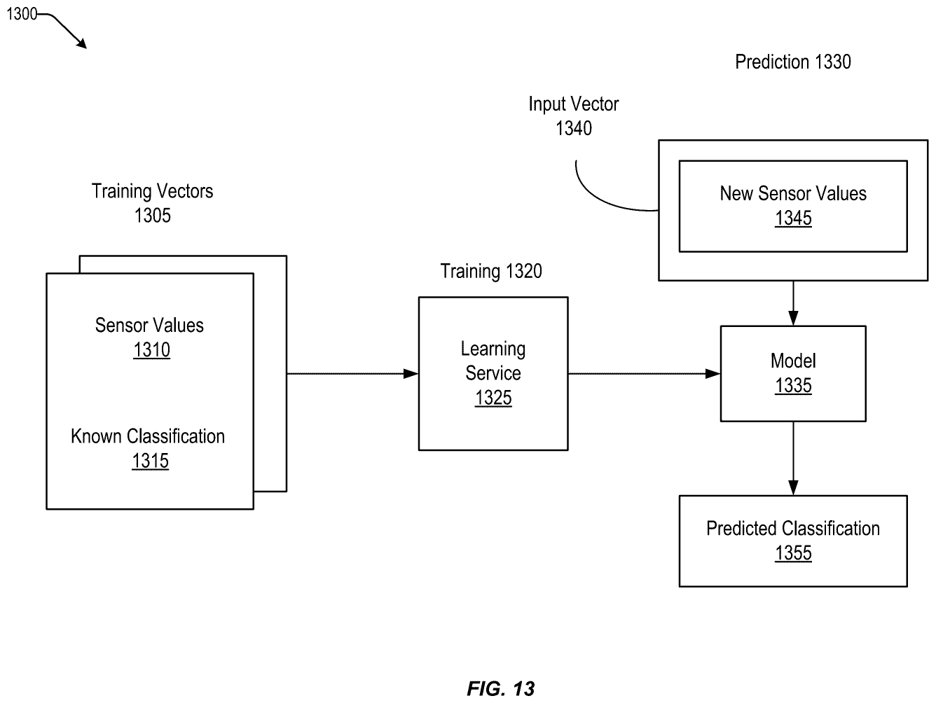

FIG. 13 depicts an architecture for training a machine learning model according to the embodiments of the present disclosure. Training vectors 1305 are shown with sensor values 1310 and a known displacement 1315. Sensor values 1310 can include the output of IMU sensors including gyroscopes, magnetometers, accelerometers, etc. For case of illustration, only two training vectors are shown, but the number of training vectors may be much larger, e.g., 10, 60, 100, 1,000, 10,000, 100,000, or more. Training vectors could be made for different physical environments, the same physical environment over different time periods.

Sensor values 1310 have property fields that can correspond to the sensor values output by the IMU sensor(s) of a target mobile device and the skilled person will appreciate the various ways that such sensor values can be configured. Known displacements 1315 include the position of an electronic device during a time period that corresponds to the time the sensor value 1310 were recorded. For example, the known displacement can be determined by an electronic device using visual odometry, or visual inertial odometry, techniques. The known displacement 1315 can be coordinates and an orientation within a reference frame. The known displacement 1315 can be determined by the same device that generated the sensor values 1310, or the known displacement 1315 and the sensor values 1310 can be generated by separate devices. For example, a mobile device with a camera can be mounted at a fixed position on an individual (e.g., on the individual's chest or on top of the individual's head). As the individual moves around a physical environment, the mounted mobile device can compare sequential images to track the mounted device's position and orientation in the environment. A second mobile device can concurrently record sensor values 1310 as the individual moves around the environment. The training vector can include a known displacement 1315 and the sensor values 1310 that correspond to that displacement. A training vector 1305 may include information about the individual that was used to record the information in the vector (e.g., height, weight, age, etc.).

Training vectors 1305 can be used by a learning service 1325 to perform training 1320. A service, such as learning service 1325, being one or more computing devices configured to execute computer code to perform one or more operations that make up the service. Learning service 1325 can optimize parameters of a model 1335 such that a quality metric (e.g., accuracy of model 1335) is achieved with one or more specified criteria. The accuracy may be measured by comparing known displacements 1315 to predicted displacements. Parameters of model 1335 can be iteratively varied to increase accuracy. Determining a quality metric can be implemented for any arbitrary function including the set of all risk, loss, utility, and decision functions.

In some embodiments of training, a gradient may be determined for how varying the parameters affects a cost function, which can provide a measure of how accurate the current state of the machine learning model is. The gradient can be used in conjunction with a learning step (e.g., a measure of how much the parameters of the model should be updated for a given time step of the optimization process). The parameters (which can include weights, matrix transformations, and probability distributions) can thus be optimized to provide an optimal value of the cost function, which can be measured as being above or below a threshold (i.e., exceeds a threshold) or that the cost function does not change significantly for several time steps, as examples. In other embodiments, training can be implemented with methods that do not require a hessian or gradient calculation, such as dynamic programming or evolutionary algorithms.

A prediction stage 1330 can provide a predicted displacement 1355 for a new entity's entity signature vector 1340 based on new sensor values 1345. The predicted displacement 1355 can be a predicted speed for the tracking mobile device corresponding to the input vector 1340. The new sensor values can be of a similar type as sensor values 1310. If new sensor values are of a different type, a transformation can be performed on the data to obtain data in a similar format as sensor values 1310. Ideally, predicted displacement 1355 corresponds to the true displacement for input vector 1340.

A “machine learning model” (ML model) can refer to a software module configured to be run on one or more processors to provide a classification or numerical value of a property of one or more samples. An ML model can be generated using sample data (e.g., training data) to make predictions on test data. One example is an unsupervised learning model. Another example type of model is supervised learning that can be used with embodiments of the present disclosure. Example supervised learning models may include different approaches and algorithms including analytical learning, statistical models, artificial neural network, backpropagation, boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), random forests, ensembles of classifiers, ordinal classification, data pre-processing, handling imbalanced datasets, statistical relational learning, or Proaftn, a multicriteria classification algorithm. The model may include linear regression, logistic regression, deep recurrent neural network (e.g., long short term memory, LSTM), hidden Markov model (HMM), linear discriminant analysis (LDA), k-means clustering, density-based spatial clustering of applications with noise (DBSCAN), random forest algorithm, support vector machine (SVM), or any model described herein. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

Examples of machine learning models include deep learning models, neural networks (e.g., deep learning neural networks), kernel-based regressions, adaptive basis regression or classification, Bayesian methods, ensemble methods, logistic regression and extensions, Gaussian processes, support vector machines (SVMs), a probabilistic model, and a probabilistic graphical model. Embodiments using neural networks can employ using wide and tensorized deep architectures, convolutional layers, dropout, various neural activations, and regularization steps.

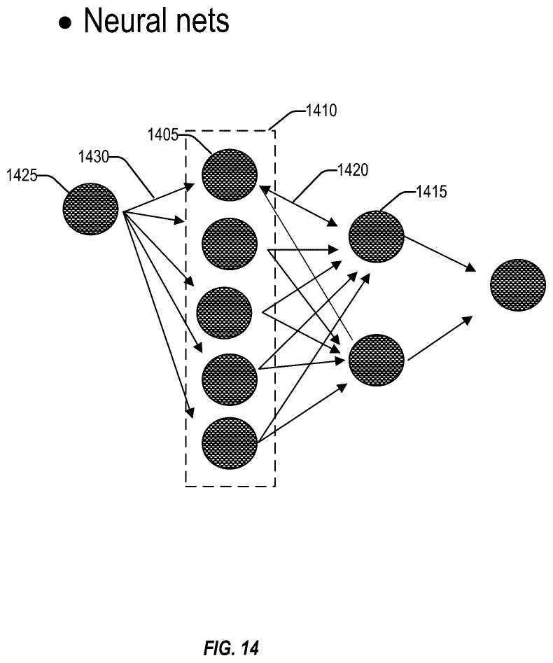

FIG. 14 shows an example machine learning model of a neural network. As an example, model 1435 can be a neural network that comprises a number of neurons (e.g., Adaptive basis functions) organized in layers. For example, neuron 1405 can be part of layer 1410. The neurons can be connected by edges between neurons. For example, neuron 1405 can be connected to neuron 1415 by edge 1420. A neuron can be connected to any number of different neurons in any number of layers. For instance, neuron 1405 can be connected to neuron 1425 by edge 1430 in addition to being connected to neuron 1415.

The training of the neural network can iteratively search for the best configuration of the parameter of the neural network for feature recognition and prediction performance. Various numbers of layers and nodes may be used. A person with skills in the art can easily recognize variations in a neural network design and design of other machine learning models. For example, neural networks can include graph neural networks that are configured to operate on unstructured data. A graph neural network can receive a graph (e.g., nodes connected by edges) as an input to the model and the graph neural network can learn the features of this input through pairwise message passing. In pairwise message passing, nodes exchange information and each node iteratively updates its representation based on the passed information. More detail about graph neural networks can be found in the following reference: Wu, Zonghan, et al. “A comprehensive survey on graph neural networks.” IEEE transactions on neural networks and learning systems 32.1 (2020): 8-2 8.

### IV. Technique for Projecting Displacement Between Ranging Sessions

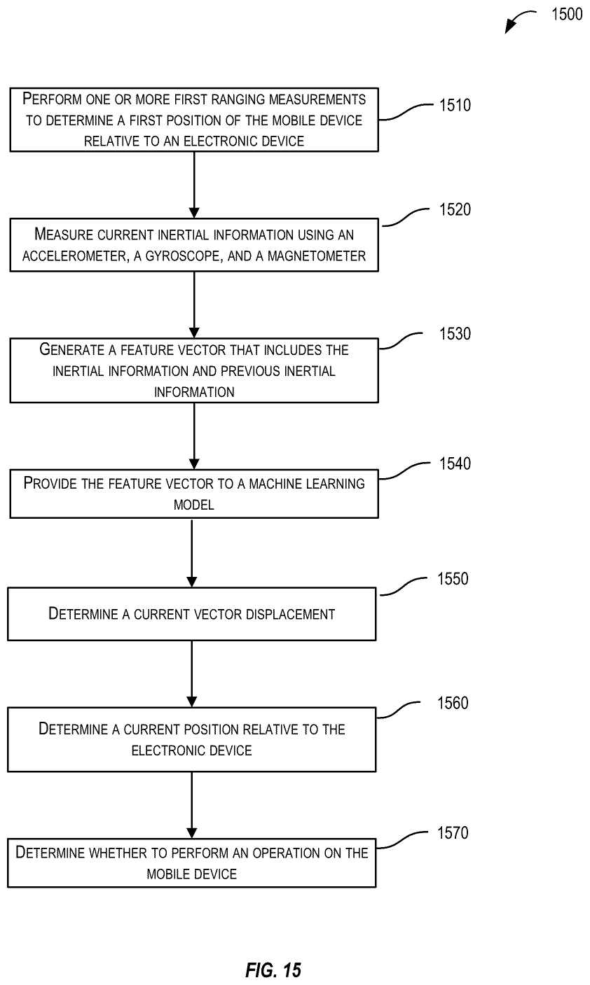

FIG. 15 is a simplified flowchart of a method 1500 for estimating the position of a mobile device according to at least one embodiment. In some implementations, one or more method blocks of FIG. 15 may be performed by a mobile device (e.g., mobile device 912, mobile device 1600; device 1700). In some implementations, one or more method blocks of FIG. 15 may be performed by another device or a group of devices separate from or including the mobile device. Additionally, or alternatively, one or more method blocks of FIG. 15 may be performed by one or more components of the mobile device, such as IMU sensor(s) 904, always-on processor 906, ranging system 910, UWB antennas 1610, UWB circuitry 1615, AOP 1630, BT/Wi-Fi antennas 1620, BT/Wi-Fi circuitry 1625, application processor 1640, processor 1718, computer readable medium 1702, wireless circuitry 1708, camera 1744, sensors 1746, etc.

At block 1510, one or more first ranging measurements are performed to determine a first position of the mobile device relative to an electronic device. The position can be one or more of a location and an orientation of the mobile device. Performing one or more first ranging measurements can include exchanging one or more ranging messages with the electronic device. The one or more first ranging measurements can be one or more properties of the exchanged messages (e.g., time of flight measurements or received signal strength indicator measurements). In some embodiments, one or more ranging measurements can be performed with two or more electronic devices to determine a position of the mobile device relative to those electronic devices. Determining the first position can include measuring inertial information to determine an orientation of the mobile device. The inertial information may include the output of an inertial measurement unit (IMU) as well as the output of other sensors (e.g., measuring magnetometer readings to determine the mobile device's orientation relative to magnetic north).

The ranging measurements may be performed by a processor (e.g., a central processing unit) of the mobile device and the processor may be instructed to enter a low power mode until the next ranging session. The instruction to enter a low power mode may include an instruction to reduce the clock speed of the mobile device. The processor may exit the low power mode at the next ranging session (e.g., by increasing the clock speed). The mobile device may be a battery powered device and the electronic device may be a wired device that receives alternating power from a wired connection to a power outlet.

At block 1520, current inertial information can be measured using an accelerometer, a gyroscope, and a magnetometer. One or more of blocks 1520-1570 can be performed any number of times after the one or more first ranging measurements are performed at block 1510 and before a next ranging session. The instructions corresponding to one or more of blocks 1520-870 can execute on an auxiliary processor that is separate from the central processing unit of the mobile device. For example, the machine learning model can execute on the auxiliary processor. The auxiliary processor may be powered on more often than the central processing unit. For example, the auxiliary b processor may be powered on for the duration of a battery level of the mobile device being above a threshold. The auxiliary processor and the central processing unit can be part of a system on a chip (SOC). The accelerometer, gyroscope, and magnetometer can be components of the mobile device, or the measurements can be performed by a different device and the measurements can be provided to the mobile device. The inertial information can include linear acceleration along one or more axes, rotational acceleration along one or more axes, and magnetic field measurements along one or more axes (e.g., three orthogonal axes; x-axis, y-axis, and z-axis).

At block 1530, a feature vector that includes the inertial information from 1520 can be generated. The feature vector can include previous inertial information from one or more previous measurements. The previous measurements can include measurements that were performed before or after the one or more first ranging measurements were performed at 1510 (e.g., before or after the previous ranging session). The previous measurements can include one or more determined positions (e.g., a position relative to the electronic device). The feature vector can include information indicating one or more characteristics of the user of the mobile device performing the techniques shown in FIG. 15. The one or more characteristics can include a user height, a user's dominant hand, etc. The feature vector can include information indicating one or more device preferences for the mobile device performing the techniques shown in FIG. 15. For example, the one or more preferences can include information indicating where a wearable mobile device is located on the user's body (e.g., smartwatch hand) and information indicating the orientation of the wearable mobile device (e.g., smartwatch crown orientation). In some embodiments, multiple feature vectors can be prepared.

At block 1540, the feature vector generated at 1530 can be provided to a machine learning model. The machine learning model can be trained using feature vectors with known displacement to determine a current vector displacement from a previous ranging position (e.g., the first position determined at block 1510). The vector displacement can be a magnitude and angle of displacement of the mobile device. The vector displacement can be a two-dimensional vector (e.g., x,y-vector) or a three-dimensional vector (e.g., x,y,z-vector). In some embodiments, the vector displacement can be the displacement of the user of the mobile device. For example, the machine learning model can be trained to use inertial information to determine the displacement of a centroid of the user's chest).

In some embodiments, one or more feature vectors can be provided to one or more machine learning models. The one or more machine learning models can have different outputs, and, for example, a first machine learning model can output a displacement of the device/the device's user and a second model can output the orientation of the mobile device. In some embodiments, the device's orientation can be determined by executing one or more rules on the inertial information. The same feature vector can be provided to multiple machine learning models or different feature vectors can be provided to the multiple models.

At block 1550, a current vector displacement can be determined. The vector displacement can be determined using the one or more machine learning models from block 1540. The vector displacement can be a displacement in a common reference frame (e.g., a cartesian coordinate system where the electronic device from 1510 is the origin (0,0)). In some embodiments, the mobile device can perform ranging measurements with multiple electronic devices and the reference frame can be shared across all devices (e.g., the first electronic device for which a position is determined is designated as the origin).

At block 1560, the first position from 1510 and the current vector displacement from block 1550 can be used to determine a current position relative to the electronic device. Determining the position can include determining a current position and a current orientation of the mobile device. In some embodiments, each of steps 1520-1570 can be performed N times and a Nth current position can be determined using the (N−1)th position and the current vector displacement for the Nth time.

At block 1570, whether to perform an operation on the mobile device can be determined based on the Nth position. The Nth position can be the current position from block 1560 for a most recent time that steps 1520-1570 were performed. Whether to perform an operation can be based on the current displacement vector from 1560 (e.g. an action may be taken in response to a user or mobile device moving towards, or away from, a particular electronic device). The Nth position can be a position relative to the electronic device from 1510 and the operation may be performed in response to comparing the magnitude of a distance between the mobile device and the electronic device to a threshold. For example, an operation may be performed if the magnitude is below a threshold or an operation may be performed if the magnitude exceeds a threshold. In some embodiments, the operation may be performed in response to determining that the mobile device is oriented so that the mobile device is pointed at the electronic device. For example, an operation may be performed if a ray extending from the Nth position along the orientation of the mobile device intersects the position of the electronic device. The ray may intersect if one or more offset angles of the ray and electronic device is below a threshold. The orientation of the mobile device may be a two-dimensional angle in a plane that is perpendicular to gravity. The angle can be an angle relative to magnetic north.

The operations can include causing changing the state of an output component of the electronic device. The output components can include a light, a display, a speaker, a physical lock (e.g., a deadbolt), etc. The operations can include changing the execution state of one or more software applications executing on the electronic device. In some embodiments, the operations can include providing information to the electronic device or receiving information from the electronic device. The operations can include changing the permissions of the electronic device with regard to a second mobile device (e.g., granting another mobile device access to the electronic device). In some embodiments, the operations can include initiating pairing between the electronic device and a second mobile device. The operations may include changing the state of an output component of the first mobile device or a second mobile device. For example, a graphical user interface of the first mobile device or the second mobile device may be changed to present an interface to control the electronic device. In another example, the second mobile device can be headphones and the operations can include causing the audio output by the headphones to change based on the orientation of either mobile device to the electronic device (e.g., spatial audio). The operations can include selecting an electronic device of a plurality of electronic devices and causing a change in the state of an output component of the selected electronic device (e.g., selecting a speaker). The operations can include ranking a plurality of electronic devices based on the position of the mobile device and the electronic devices.

The techniques may include performing one or more second ranging measurements. The second ranging measurements can be performed during a next ranging session. The next ranging session can be initiated at the conclusion of a timer, after a threshold number of vector displacements have been determined (e.g., after the techniques in blocks 1520-1570 have been performed a threshold number of times), if the magnitude of the displacement vector exceeds a threshold, if the aggregate magnitude of the displacement vectors since a first ranging session (e.g., block 1510) exceed a threshold. The next ranging session can be performed in response to a detected event at the mobile device. The detected event can be an input to the mobile device, the execution of a software application on the mobile device, or the discovery of an electronic device (e.g., receiving an advertising message from an electronic device that has not performed ranging with the mobile device within a threshold amount of time). The detected event can be the uncertainty for the device's position exceeding a threshold (e.g., as determined by the position estimate system; an uncertainty output by a particle filter). Triggering the next ranging session may include changing the cadence for future ranging sessions (e.g., for a fixed time period or for a fixed number of subsequent ranging sessions).

Method 1500 may include additional implementations, such as any single implementation or any combination of implementations described below and/or in connection with one or more other processes described elsewhere herein.

Although FIG. 15 shows example blocks of method 1500, in some implementations, method 1500 may include additional blocks, fewer blocks, different blocks, or differently arranged blocks than those depicted in FIG. 15. Additionally, or alternatively, two or more of the blocks of method 1500 may be performed in parallel.

### VI. UWB Device

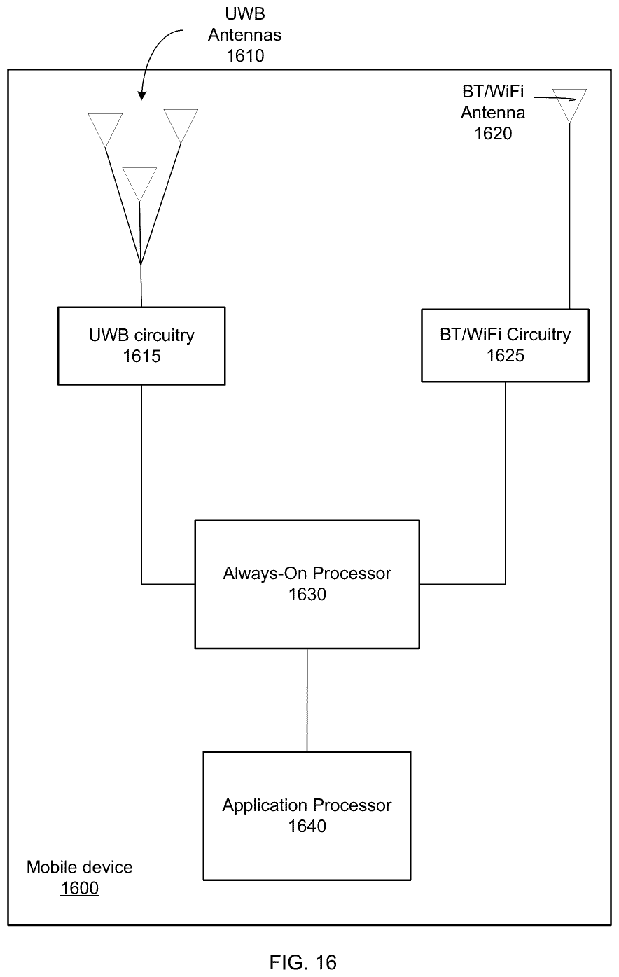

FIG. 16 is a block diagram of components of a mobile device 1600 operable to perform ranging according to embodiments of the present disclosure. Mobile device 1600 includes antennas for at least two different wireless protocols, as described above. The first wireless protocol (e.g., Bluetooth) may be used for authentication and exchanging ranging settings. The second wireless protocol (e.g., UWB) may be used for performing ranging with another mobile device.

As shown, mobile device 1600 includes UWB antennas 1610 for performing ranging. UWB antennas 1610 are connected to UWB circuitry 1615 for analyzing detected signals from UWB antennas 1610. In some embodiments, mobile device 1600 includes three or more UWB antennas, e.g., for performing triangulation. The different UWB antennas can have different orientations, e.g., two in one direction and a third in another direction. The orientations of the UWB antennas can define a field of view for ranging. As an example, the field of view can span 120 degrees. Such regulation can allow a determination of which direction a user is pointing a device relative to one or more other nearby devices. The field of view may include any one or more of pitch, yaw, or roll angles.

UWB circuitry 1615 can communicate with an always-on processor (AOP) 1630, which can perform further processing using information from UWB messages. For example, AOP 1630 can perform the ranging calculations using timing data provided by UWB circuitry 1615. AOP 1630 and other circuits of the device can include dedicated circuitry and/or configurable circuitry, e.g., via firmware or other software.

As shown, mobile device 1600 also includes Bluetooth (BT)/Wi-Fi antenna 1620 for communicating data with other devices. Bluetooth (BT)/Wi-Fi antenna 1620 is connected to BT/Wi-Fi circuitry 1625 for analyzing detected signals from BT/Wi-Fi antenna 1620. For example, BT/Wi-Fi circuitry 1625 can parse messages to obtain data (e.g., an authentication tag), which can be sent on to AOP 1630. In some embodiments, AOP 1630 can perform authentication using an authentication tag. Thus, AOP 1630 can store or retrieve a list of authentication tags for which to compare a received tag against, as part of an authentication process. In some implementations, such functionality could be achieved by BT/Wi-Fi circuitry 1625.

In other embodiments, UWB circuitry 1615 and BT/Wi-Fi circuitry 1625 can alternatively or in addition be connected to application processor 1640, which can perform similar functionality as AOP 1630. Application processor 1640 typically requires more power than AOP 1630, and thus power can be saved by AOP 1630 handling certain functionality, so that application processor 1640 can remain in a sleep state, e.g., an off state. As an example, application processor 1640 can be used for communicating audio or video using BT/Wi-Fi, while AOP 1630 can coordinate transmission of such content and communication between UWB circuitry 1615 and BT/Wi-Fi circuitry 1625. For instance, AOP 1630 can coordinate timing of UWB messages relative to BT advertisements.

Coordination by AOP 1630 can have various benefits. For example, a first user of a sending device may want share content with another user, and thus ranging may be desired with a receiving device of this other user. However, if many people are in the same room, the sending device may need to distinguish a particular device among the multiple devices in the room, and potentially determine which device the sending device is pointing to. Such functionality can be provided by AOP 1630. In addition, it is not desirable to wake up the application processor of every other device in the room, and thus the AOPs of the other devices can perform some processing of the messages and determine that the destination address is for a different device.

To perform ranging, BT/Wi-Fi circuitry 1625 can analyze an advertisement signal from another device to determine that the other device wants to perform ranging, e.g., as part of a process for sharing content. BT/Wi-Fi circuitry 1625 can communicate this notification to AOP 1630, which can schedule UWB circuitry 1615 to be ready to detect UWB messages from the other device.

For the device initiating ranging, its AOP can perform the ranging calculations. Further, the AOP can monitor changes in distance between the other devices. For example, AOP 1630 can compare the distance to a threshold value and provide an alert when the distance exceeds a threshold, or potentially provide a reminder when the two devices become sufficiently close. An example of the former might be when a parent wants to be alerted when a child (and presumably the child's device) is too far away. An example of the latter might be when a person wants to be reminded to bring up something when talking to a user of the other device. Such monitoring by the AOP can reduce power consumption by the application processor.

### VII. Example Device

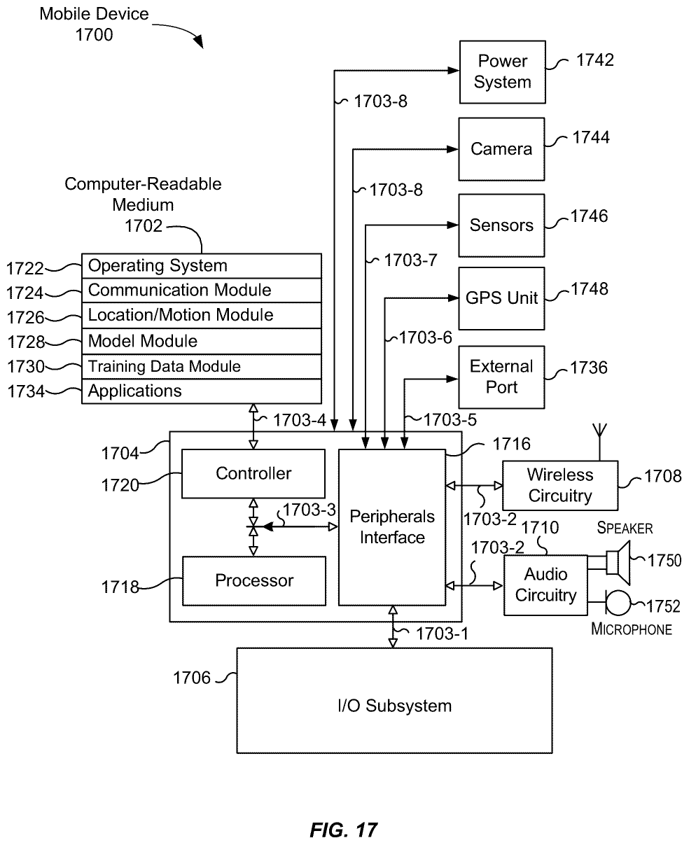

FIG. 17 is a block diagram of an example device 1700, which may be a mobile device according to embodiments of the present disclosure. Device 1700 generally includes computer-readable medium 1702, a processing system 1704, an Input/Output (I/O) subsystem 1706, wireless circuitry 1708, and audio circuitry 1710 including speaker 1750 and microphone 1752. These components may be coupled by one or more communication buses or signal lines 1703. Device 1700 can be any portable mobile device, including a handheld computer, a tablet computer, a mobile phone, laptop computer, tablet device, media player, personal digital assistant (PDA), a key fob, a car key, an access card, a multi-function device, a mobile phone, a portable gaming device, a car display unit, or the like, including a combination of two or more of these items.

It should be apparent that the architecture shown in FIG. 17 is only one example of an architecture for device 1700, and that device 1700 can have more or fewer components than shown, or a different configuration of components. The various components shown in FIG. 17 can be implemented in hardware, software, or a combination of both hardware and software, including one or more signal processing and/or application specific integrated circuits.

Wireless circuitry 1708 is used to send and receive information over a wireless link or network to one or more other devices' conventional circuitry such as an antenna system, an RF transceiver, one or more amplifiers, a tuner, one or more oscillators, a digital signal processor, a CODEC chipset, memory, etc. Wireless circuitry 1708 can use various protocols, e.g., as described herein.

Wireless circuitry 1708 is coupled to processing system 1704 via peripherals interface 1716. Interface 1716 can include conventional components for establishing and maintaining communication between peripherals and processing system 1704. Voice and data information received by wireless circuitry 1708 (e.g., in speech recognition or voice command applications) is sent to one or more processors 1718 via peripherals interface 1716. One or more processors 1718 are configurable to process various data formats for one or more application programs 1734 stored on medium 1702.

Peripherals interface 1716 couple the input and output peripherals of the device to processor 1718 and computer-readable medium 1702. One or more processors 1718 communicate with computer-readable medium 1702 via a controller 1720. Computer-readable medium 1702 can be any device or medium that can store code and/or data for use by one or more processors 1718. Medium 1702 can include a memory hierarchy, including cache, main memory, and secondary memory.

Device 1700 also includes a power system 1742 for powering the various hardware components. Power system 1742 can include a power management system, one or more power sources (e.g., battery, alternating current (AC)), a recharging system, a power failure detection circuit, a power converter or inverter, a power status indicator (e.g., a light emitting diode (LED)), and any other components typically associated with the generation, management and distribution of power in mobile devices.

In some embodiments, device 1700 includes a camera 1744. In some embodiments, device 1700 includes sensors 1746. Sensors 1746 can include accelerometers, compasses, gyrometers, pressure sensors, audio sensors, light sensors, barometers, and the like. Sensors 1746 can be used to sense location aspects, such as auditory or light signatures of a location.

In some embodiments, device 1700 can include a GPS receiver, sometimes referred to as a GPS unit 1748. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information. In other embodiments, device 1700 may be configured to identify GLONASS signals, or any other similar type of satellite navigational signal.

One or more processors 1718 run various software components stored in medium 1702 to perform various functions for device 1700. In some embodiments, the software components include an operating system 1722, a communication module (or set of instructions) 1724, a location module (or set of instructions) 1726, a model module 1728, a training data module 1730, and other applications (or set of instructions) 1734, such as a car locator app and a navigation app.

The model module 1728 can use the input from sensors 1746 to predict the relative position of the mobile device 1700. This input can include inertial measurement units measured by the sensors 1746. The model module can include a kinematics model, a motion model, and one or more additional models. Training data model 1730 can correlate sensor data, from sensors 1746, to positions determined by the model module 1728, GPS Unit 1748, or wireless circuitry 1708, to create training data.

Operating system 1722 can be any suitable operating system, including iOS, Mac OS, Darwin, RTXC, LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 1724 facilitates communication with other devices over one or more external ports 1736 or via wireless circuitry 1708 and includes various software components for handling data received from wireless circuitry 1708 and/or external port 1736. External port 1736 (e.g., USB, FireWire, Lightning connector, 60-pin connector, etc.) is adapted for coupling directly to other devices or indirectly over a network (e.g., the Internet, wireless LAN, etc.).

Location/motion module 1726 can assist in determining the current position (e.g., coordinates or other geographic location identifier) and motion of device 1700. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 1726 receives data from GPS unit 1748 and analyzes the signals to determine the current position of the mobile device. In some embodiments, location/motion module 1726 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 1708 and is passed to location/motion module 1726. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 1700 based on the position coordinates of the corresponding transmitters. Regardless of the specific location technology used, location/motion module 1726 receives information from which a location fix can be derived, interprets that information, and returns location information, such as geographic coordinates, latitude/longitude, or other location fix data.

The one or more application programs 1734 on the mobile device can include any applications installed on the device 1700, including without limitation, a browser, address book, contact list, email, instant messaging, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating, and displaying graphical objects (including without limitation text, web pages, icons, digital images, animations, and the like) on a display surface. In another example, a timer module can be a software timer. The timer module can also be implemented in hardware. The time module can maintain various timers for any number of events.

The I/O subsystem 1706 can be coupled to a display system (not shown), which can be a touch-sensitive display. The display system displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 1706 can include a display and user input devices such as a keyboard, mouse, and/or track pad. In some embodiments, I/O subsystem 1706 can include a touch-sensitive display. A touch-sensitive display can also accept input from the user based on haptic and/or tactile contact. In some embodiments, a touch-sensitive display forms a touch-sensitive surface that accepts user input. The touch-sensitive display/surface (along with any associated modules and/or sets of instructions in medium 1702) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, the I/O subsystem can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 1700 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display, or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering and use of data available from various sources to improve prediction of users that a user may be interested in communicating with. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to predict users that a user may want to communicate with at a certain time and place. Accordingly, use of such personal information data included in contextual information enables people centric prediction of people a user may want to interact with at a certain time and place. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of people centric prediction services, the present technology can be configured to allow users to select to “opt in” or “opt out” of participation in the collection of personal information data during registration for services or anytime thereafter. In another example, users can select not to provide location information for recipient suggestion services. In yet another example, users can select to not provide precise location information, but permit the transfer of location zone information. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, users that a user may want to communicate with at a certain time and place may be predicted based on non-personal information data or a bare minimum amount of personal information, such as the content being requested by the device associated with a user, other non-personal information, or publicly available information.

Although the disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art. Where a conflict exists between the instant application and a reference provided herein, the instant application shall dominate.

1.-41. (canceled)

42. A method comprising performing, by a first portable device:
at a plurality of times while a user of the first portable device is moving with the first portable device:
performing ranging at a respective position with a second device to determine a respective distance, thereby determining a plurality of respective distances, wherein the second device is stationary;
obtaining raw measurements from a motion sensor of the first portable device;
using the raw measurements at the plurality of times to determine relative positions at the plurality of times, the relative positions determined from an initial position; and
estimating a second position of the second device that optimizes a loss function that includes differences between the respective distances at the relative positions and an actual distance between the relative positions and the second position.

43. The method of claim 42, wherein using the raw measurements to determine the relative positions comprises, at each of the plurality of times:
integrating an acceleration of the first portable device to calculate a velocity of the first portable device; and
integrating the velocity of the first portable device to calculate a relative position of the first portable device.

44. The method of claim 43, further comprising:
providing the raw measurements as input to a motion model;
receiving a probability that the first portable device is at the relative position as output from the motion model; and
updating the relative position of the of the first portable device based on the probability.

45. The method of claim 42, wherein determining relative positions comprises, at each of the plurality of times:
providing the raw measurements as input to a motion model; and
receiving a probability that the first portable device is at a relative position as output from the motion model.

46. The method of claim 42, wherein using the raw measurements comprises, at each of the plurality of times:
assigning a confidence score to the raw measurements; and
discarding the raw measurements if the confidence score is below a confidence threshold.

47. The method of claim 42, wherein determining the plurality of respective distances comprises:
detecting that movement of the first portable device is below a threshold; and
prompting the user to move via an output system of the first portable device.

48. The method of claim 42, wherein determining the plurality of respective distances comprises:
detecting that movement of the first portable device is above a threshold; and
prompting the user to continue moving via an output system of the first portable device.

49. A computing device, comprising:
one or more memories; and
one or more processors in communication with the one or more memories and configured to execute instructions stored in the one or more memories to performing operations to:
at a plurality of times while a user of a first portable device is moving with the first portable device:
perform ranging at a respective position with a second device to determine a respective distance, thereby determining a plurality of respective distances, wherein the second device is stationary;
obtain raw measurements from a motion sensor of the first portable device;
use the raw measurements at the plurality of times to determine relative positions at the plurality of times, the relative positions determined from an initial position; and
estimate a second position of the second device that optimizes a loss function that includes differences of the respective distances between the relative positions and an actual distance between the relative positions and the second position.

50. The computing device of claim 49, wherein using the raw measurements to determine the relative positions comprises operations to, at each of the plurality of times:
integrate an acceleration of the first portable device to calculate a velocity of the first portable device; and
integrate the velocity of the first portable device to calculate a relative position of the first portable device.

51. The computing device of claim 50, further comprising operations to:
provide the raw measurements as input to a motion model;
receive a probability that the first portable device is at the relative position as output from the motion model; and
update the relative position of the of the first portable device based on the probability.

52. The computing device of claim 49, wherein determining relative positions comprises operations to, at each of the plurality of times:
provide the raw measurements as input to a motion model; and
receive a probability that the first portable device is at a relative position as output from the motion model.

53. The computing device of claim 49, wherein using the raw measurements comprises operations to, at each of the plurality of times:
assign a confidence score to the raw measurements; and
discard the raw measurements if the confidence score is below a confidence threshold.

54. The computing device of claim 49, wherein determining the plurality of respective distances comprises operations to:
detect that movement of the first portable device is below a threshold; and
prompt the user to move via an output system of the first portable device.

55. The computing device of claim 49, wherein determining the plurality of respective distances comprises operations to:
detect that movement of the first portable device is above a threshold; and
prompt the user to continue moving via an output system of the first portable device.

56. A computer-readable medium storing a plurality of instructions that, when executed by one or more processors of a computing device, cause the one or more processors to perform operations to:
at a plurality of times while a user of a first portable device is moving with the first portable device:
perform ranging at a respective position with a second device to determine a respective distance, thereby determining a plurality of respective distances, wherein the second device is stationary;
obtain raw measurements from a motion sensor of the first portable device;
use the raw measurements at the plurality of times to determine relative positions at the plurality of times, the relative positions determined from an initial position; and
estimate a second position of the second device that optimizes a loss function that includes differences of between respective distances at the relative positions and an actual distance between the relative positions and the second position.

57. The computer-readable medium of claim 56, wherein using the raw measurements to determine the relative positions comprises operations to, at each of the plurality of times:
integrate an acceleration of the first portable device to calculate a velocity of the first portable device; and
integrate the velocity of the first portable device to calculate a relative position of the first portable device.

58. The computer-readable medium of claim 57, further comprising operations to:
provide the raw measurements as input to a motion model;
receive a probability that the first portable device is at the relative position as output from the motion model; and
update the relative position of the of the first portable device based on the probability.

59. The computer-readable medium of claim 56, wherein determining relative positions comprises operations to, at each of the plurality of times:
provide the raw measurements as input to a motion model; and
receive a probability that the first portable device is at a relative position as output from the motion model.

60. The computer-readable medium of claim 56, wherein using the raw measurements comprises operations to, at each of the plurality of times:
assign a confidence score to the raw measurements; and
discard the raw measurements if the confidence score is below a confidence threshold.

61. The computer-readable medium of claim 56, wherein determining the plurality of respective distances comprises operations to:
detect that movement of the first portable device is below a threshold; and
prompt the user to move via an output system of the first portable device.
